(19) United States
(12) Patent Application Publication
(10) Pub. No.: US 2021/0271650 A1
(43) Pub. Date: Sep. 2, 2021

(54) METHOD AND APPARATUS FOR PERFORMING DEDUPLICATION MANAGEMENT WITH AID OF COMMAND-RELATED FILTER

(71) Applicant: Silicon Motion, Inc., Hsinchu County (TW)

(72) Inventors: Wen-Long Wang, Hsinchu City (TW); Yu-Teng Chiu, Hsinchu City (TW); Yi-Feng Lin, Changhua County (TW)

(21) Appl. No.: 17/140,147

(22) Filed: Jan. 4, 2021

Related U.S. Application Data
(60) Provisional application No. 62/983,763, filed on Mar. 2, 2020.

(51) Int. Cl. G06F 16/215; G06F 9/54

(52) U.S. Cl. CPC G06F 16/215; G06F 9/54

(57) ABSTRACT

A method for performing deduplication management with aid of a command-related filter and associated apparatus are provided. The method may include: utilizing at least one program module among multiple program modules running on a host device within the storage server to control the storage server to write multiple sets of user data of a user of the storage server into a storage device layer of the storage server, and utilizing a fingerprint-based deduplication management module among the multiple program modules to create and store multiple fingerprints into a fingerprint storage of the storage server to be respective representatives of the multiple sets of user data at the storage server, for minimizing calculation loading regarding deduplication control; and utilizing the command-related filter to at least convert a set of commands into a single command to eliminate unnecessary command(s), for executing the single command rather than all of the set of commands.

### CROSS REFERENCE TO RELATED APPLICATIONS

This application claims the benefit of U.S. Provisional Application No. 62/983,763, which was filed on Mar. 2, 2020, and is included herein by reference.

### BACKGROUND OF THE INVENTION

### 1. Field of the Invention

The present invention is related to storage control, and more particularly, to a method and apparatus for performing deduplication management with aid of a command-related filter, where examples of the apparatus may include, but are not limited to: the whole of a storage server, a host device within the storage server, a processing circuit within the host device, and at least one processor/processor core (e.g. Central Processing Unit (CPU)/CPU core) running one or more program modules corresponding to the method within the processing circuit.

### 2. Description of the Prior Art

A server may be used for storing user data. For example, a storage server may be arranged to implement remote storage such as cloud servers capable of storing data for users. As the number of users of the storage server may increase, and as the data of the users may increase as time goes by, the storage capacity of the storage server may easily become insufficient. Adding more storage devices into the storage server may be helpful for expanding the storage capacity of the storage server. However, some problems may occur. For example, the overall cost of the storage server may increase rapidly. For another example, there may be an upper limit of the number of storage devices in the storage server due to the architecture of the storage server. A deduplication method has been proposed in the related art to try reducing the speed of using up the storage capacity of the storage server, but the overall performance of the storage server may be degraded due to associated calculations. Thus, a novel architecture is required for enhancing storage control to allow a storage server to operate normally and smoothly during daily use.

### SUMMARY OF THE INVENTION

It is therefore an objective of the present invention to provide a method for performing deduplication management with aid of a command-related filter, and to provide associated apparatus such as a storage server, a host device within the storage server, etc., in order to solve the above-mentioned problems.

It is another objective of the present invention to provide a method for performing deduplication management with aid of a command-related filter, and to provide associated apparatus such as a storage server, a host device within the storage server, etc., in order to achieve an optimal performance without introducing a side effect or in a way that less likely to introduce a side effect.

At least one embodiment of the present invention provides a method for performing deduplication management with aid of a command-related filter, wherein the method is applied to a storage server. The method may comprise: utilizing at least one program module among multiple program modules running on a host device within the storage server to control the storage server to write multiple sets of user data of a user of the storage server into a storage device layer of the storage server, and utilizing a fingerprint-based deduplication management module among the multiple program modules to create and store multiple fingerprints into a fingerprint storage of the storage server to be respective representatives of the multiple sets of user data at the storage server, for minimizing calculation loading regarding deduplication control to enhance overall performance of the storage server, wherein the storage server comprises the host device and the storage device layer, the storage device layer comprises at least one storage device that is coupled to the host device, the host device is arranged to control operations of the storage server, and said at least one storage device is arranged to store information for the storage server; and utilizing the command-related filter within the fingerprint-based deduplication management module to monitor multiple commands at a processing path among multiple processing paths within the fingerprint-based deduplication management module, determine a set of commands regarding user-data change among the multiple commands at least according to addresses respectively carried by the set of commands, and convert the set of commands into a single command to eliminate one or more unnecessary commands among the set of commands, for executing the single command rather than all of the set of commands, thereby further enhancing the overall performance of the storage server.

In addition to the above method, the present invention also provides a host device. The host device may comprise a processing circuit that is arranged to control the host device to perform fingerprint-based deduplication management in a storage server, wherein the storage server comprises the host device and a storage device layer, the storage device layer comprises at least one storage device that is coupled to the host device, the host device is arranged to control operations of the storage server, and the aforementioned at least one storage device is arranged to store information for the storage server. For example, at least one program module among multiple program modules running on the host device within the storage server controls the storage server to write multiple sets of user data of a user of the storage server into the storage device layer of the storage server, and a fingerprint-based deduplication management module among the multiple program modules creates and stores multiple fingerprints into a fingerprint storage of the storage server to be respective representatives of the multiple sets of user data at the storage server, for minimizing calculation loading regarding deduplication control to enhance overall performance of the storage server; and the command-related filter within the fingerprint-based deduplication management module monitors multiple commands at a processing path among multiple processing paths within the fingerprint-based deduplication management module, determines a set of commands regarding user-data change among the multiple commands at least according to addresses respectively carried by the set of commands, and converts the set of commands into a single command to eliminate one or more unnecessary commands among the set of commands, for executing the single command rather than all of the set of commands, thereby further enhancing the overall performance of the storage server.

In addition to the above method, the present invention also provides a storage server. The storage server may comprise a host device and a storage device layer, where the host device is arranged to control operations of the storage server. For example, the host device may comprise a processing circuit that is arranged to control the host device to perform fingerprint-based deduplication management in the storage server. In addition, the storage device layer may comprise at least one storage device that is coupled to the host device, and the aforementioned at least one storage device is arranged to store information for the storage server. For example, at least one program module among multiple program modules running on the host device within the storage server controls the storage server to write multiple sets of user data of a user of the storage server into the storage device layer of the storage server, and a fingerprint-based deduplication management module among the multiple program modules creates and stores multiple fingerprints into a fingerprint storage of the storage server to be respective representatives of the multiple sets of user data at the storage server, for minimizing calculation loading regarding deduplication control to enhance overall performance of the storage server; and the command-related filter within the fingerprint-based deduplication management module monitors multiple commands at a processing path among multiple processing paths within the fingerprint-based deduplication management module, determines a set of commands regarding user-data change among the multiple commands at least according to addresses respectively carried by the set of commands, and converts the set of commands into a single command to eliminate one or more unnecessary commands among the set of commands, for executing the single command rather than all of the set of commands, thereby further enhancing the overall performance of the storage server.

The present invention method and associated apparatus can enhance the overall performance of the storage server. For example, the storage server can operate according to multiple control schemes of the method. More particularly, under control of the processing circuit running one or more program modules corresponding to the method, the storage server can perform deduplication management with aid of the command-related filter, to achieve an optimal performance without introducing a side effect or in a way that less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a storage server according to an embodiment of the present invention.

FIG. 2 illustrates a method for performing deduplication management with aid of a command-related filter according to an embodiment of the present invention.

FIG. 3 illustrates a fingerprint (FP)-based deduplication control scheme of the method shown in FIG. 2 according to an embodiment of the present invention.

FIG. 4 illustrates a fingerprint lookup control scheme of the method shown in FIG. 2 according to an embodiment of the present invention.

FIG. 5 illustrates a fingerprint delete control scheme of the method shown in FIG. 2 according to an embodiment of the present invention.

FIG. 6 illustrates a fingerprint retirement control scheme of the method shown in FIG. 2 according to an embodiment of the present invention.

FIG. 7 illustrates a byte-by-byte-compare (BBBC) control scheme of the method shown in FIG. 2 according to an embodiment of the present invention.

FIG. 8 illustrates a save data control scheme of the method shown in FIG. 2 according to an embodiment of the present invention.

FIG. 9 illustrates a delete data control scheme of the method shown in FIG. 2 according to an embodiment of the present invention.

FIG. 10 illustrates an accessing control scheme of the method shown in FIG. 2 according to an embodiment of the present invention.

FIG. 11 illustrates a read data control scheme of the method shown in FIG. 2 according to an embodiment of the present invention.

FIG. 12 illustrates a read data control scheme of the method shown in FIG. 2 according to another embodiment of the present invention, where the deduplication module has target data.

FIG. 13 illustrates a read data control scheme of the method shown in FIG. 2 according to yet another embodiment of the present invention, where the deduplication module has target data before, but already removes it due to retiring a corresponding fingerprint and remove the target data.

FIG. 14 illustrates a filtering and processing control scheme of the method shown in FIG. 2 according to an embodiment of the present invention.

FIG. 15 illustrates an update request control scheme of the method shown in FIG. 2 according to an embodiment of the present invention.

FIG. 16 illustrates some examples of the associated processing of the update request control scheme shown in FIG. 15 in a situation where FP is found on in-memory table.

FIG. 17 illustrates some examples of the associated processing of the update request control scheme shown in FIG. 15 in a situation where FP is found on in-storage table.

FIG. 18 illustrates some examples of the associated processing of the update request control scheme shown in FIG. 15 in a situation where FP is not found on any table.

FIG. 19 illustrates enhanced scalability obtained from using the command-related filter according to an embodiment of the present invention.

### DETAILED DESCRIPTION

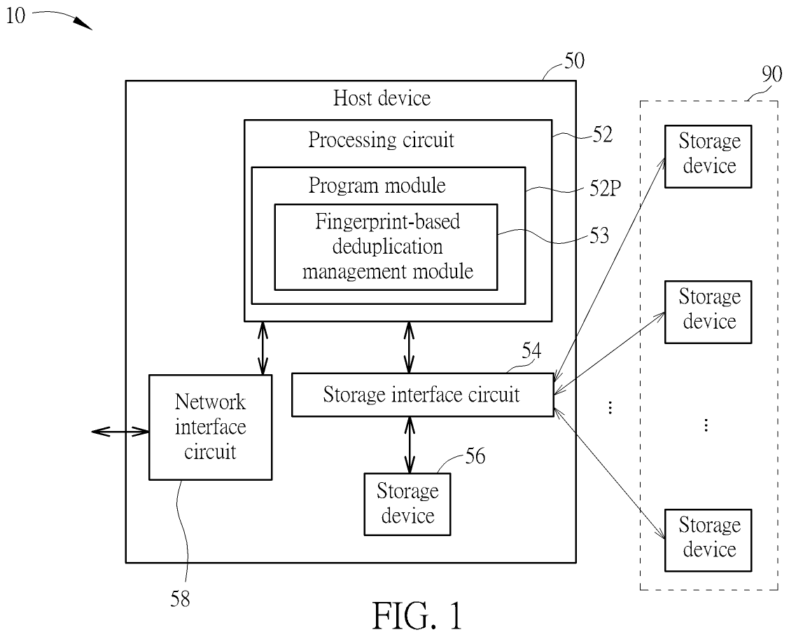

FIG. 1 is a diagram of a storage server 10 according to an embodiment of the present invention. The storage server 10 comprises a host device 50, and comprises at least one storage device (e.g. one or more storage devices) such as a plurality of storage devices 90. The plurality of storage devices 90 are coupled to the host device 50. According to this embodiment, the host device 50 can be configured to control operations of the storage server 10, and the plurality of storage devices 90 can be configured to store information for the storage server 10. As shown in FIG. 1, the host device 50 may comprise a processing circuit 52 (e.g. at least one processor/processor core and associated circuits such as Random Access Memory (RAM), bus, etc.) for controlling operations of the host device 50, at least one storage interface circuit 54 for coupling the plurality of storage devices 90 and for coupling storage or memory devices (e.g. one or more Hard Disk Drive (HDDs) and/or one or more Solid State Drives (SSDs)) at the host device 50, and a network interface circuit 58 for coupling the host device 50 to at least one network. The storage or memory devices may comprise at least one storage device such as one or more storage devices, which may be collectively referred to as the storage device 56. For example, the storage device 56 may comprise a set of storage devices, where one of them may be utilized as a system disk of the host device 50, and the others can be configured to store user data for the host device 50, but the present invention is not limited thereto. For another example, the storage device 56 may comprise one storage device, and this storage device may be utilized as the system disk of the host device 50. For better comprehension, program modules 52P running on the processing circuit 52 may comprise one or more layers of software modules, such as an operating system (OS), drivers, application programs, etc., but the present invention is not limited thereto.

According to this embodiment, the processing circuit 52 running the program modules 52P (more particularly, a fingerprint-based deduplication management module 53) can be configured to control operations of the host device 50, for example, control the host device 50 to perform fingerprint-based deduplication management in the storage server 10, and the storage interface circuit 54 may conform to one or more specifications (e.g. one or more of Serial Advanced Technology Attachment (Serial ATA, or SATA) specification, Peripheral Component Interconnect (PCI) specification, Peripheral Component Interconnect Express (PCIe) specification, Non-Volatile Memory Express (NVMe) specification, NVMe-over-Fabrics (NVMeoF) specification, Small Computer System Interface (SCSI) specification, Universal Flash Storage (UFS) specification, etc.), and can perform communications according to the one or more specifications, to allow the processing circuit 52 running the program modules 52P to access the storage device 56 and the plurality of storage devices 90 through the storage interface circuit 54. Additionally, the network interface circuit 58 can be configured to provide wired or wireless network connections, and one or more client devices corresponding to one or more users can access (e.g. read or write) user data in the storage server 10 (e.g. the storage device 56 and the plurality of storage devices 90 therein) through the wired or wireless network connections.

In the architecture shown in FIG. 1, the storage server 10 can be illustrated to comprise the host device 50 and the plurality of storage devices 90 coupled to the host device 50, but the present invention is not limited thereto. For example, the host device 50 may further comprise a shell/case/casing (e.g. a computer casing, which can be made of metal and/or one or more other materials) for installing the components of the host device 50 such as that shown in FIG. 1 (e.g. the processing circuit 52, the storage interface circuit 54, the network interface circuit 58, etc.) and at least one portion (e.g. a portion or all) of the plurality of storage devices 90. For another example, the storage server 10 may further comprise at least one switch circuit (e.g. one or more switch circuits) coupled between the host device 50 and at least one portion (e.g. a portion or all) of the plurality of storage devices 90, for performing signal switching between the host device 50 and the aforementioned at least one portion of the plurality of storage devices 90.

According to some embodiments, the processing circuit 52 running the program modules 52P or the storage interface circuit 54 can configure at least one portion (e.g. a portion or all) of the plurality of storage devices 90 to form a storage pool architecture, where the associated addresses of an address system of the storage pool architecture, such as logical block addresses (LBAs), can be storage pool addresses such as storage pool LBAs (SLBAs), but the present invention is not limited thereto. According to some embodiments, the processing circuit 52 running the program modules 52P or the storage interface circuit 54 can configure at least one portion (e.g. a portion or all) of the plurality of storage devices 90 to form a Redundant Array of Independent Disks (RAID) of the storage server 10, such as an All Flash Array (AFA).

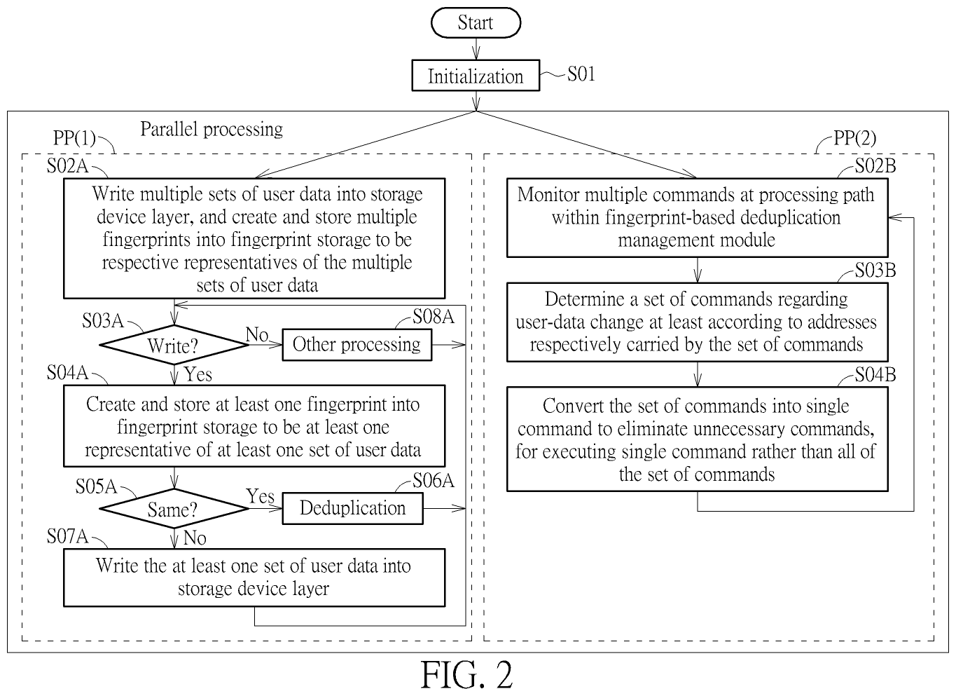

FIG. 2 illustrates a method for performing deduplication management with aid of a command-related filter according to an embodiment of the present invention. The method can be applied to the storage server 10, and the processing circuit 52 running the program modules 52P can control the storage server 10 according to the method. For example, under control of the processing circuit 52 running the program modules 52P (e.g. the fingerprint-based deduplication management module 53, etc.) corresponding to the method, the storage server can perform parallel processing, and more particularly, perform first partial processing PP(1) and second partial processing PP(2) in a parallel manner, where the first partial processing PP(1) may comprise operations of Steps S02A-S07A, and the second partial processing PP(2) may comprise operations of Steps S02B-S04B, but the present invention is not limited thereto.

In Step S01, the storage server 10 can perform initialization. For example, the storage server 10 (e.g. the processing circuit 52 running the program modules 52P) can activate various control mechanisms respectively corresponding to multiple control schemes of the method, for controlling the storage server 10 to operate correctly and efficiently.

In Step S02A, in response to one or more write requests, the storage server 10 can utilize at least one program module among the program modules 52P running on the host device 50 within the storage server 10 to control the storage server 10 to write multiple sets of user data of a user (e.g. any of the one or more users) of the storage server 10 into a storage device layer of the storage server 10, and utilize the fingerprint-based deduplication management module 53 among the program modules 52P to create and store multiple fingerprints (e.g. calculation results obtained from performing fingerprint calculations on the multiple sets of user data, respectively) into a fingerprint storage of the storage server 10 to be respective representatives of the multiple sets of user data at the storage server 10, for minimizing calculation loading regarding deduplication control to enhance overall performance of the storage server 10, where the storage server 10 comprises the host device 50 and the storage device layer, and the storage device layer comprises at least one storage device such as the plurality of storage devices 90. For example, the one or more write requests can be sent from a client device of the user, and can be asking for writing the multiple sets of user data into the storage server 10.

In Step S03A, when receiving an accessing request, the storage server 10 (e.g. the processing circuit 52 running the program modules 52P) can determine whether the accessing request is a write request (labeled “Write” for brevity). If Yes, Step S04A is entered; if No, Step S08A is entered. For example, the client device of the user may have sent the accessing request to the storage server 10 to ask for accessing the storage server 10.

In Step S04A, in response to the accessing request being the write request, the storage server 10 can utilize the fingerprint-based deduplication management module 53 to create and store at least one fingerprint into the fingerprint storage to be at least one representative of at least one set of user data. For example, the write request can be sent from the client device of the user, and can be asking for writing the at least one set of user data into the storage server 10.

In Step S05A, the storage server 10 (e.g. the processing circuit 52 running the program modules 52P) can determine whether the at least one set of user data (e.g. the data carried by the write request, such as the data to be written) is the same as any existing data stored in the storage device layer of the storage server 10. If Yes, Step S06A is entered; if No, Step S07A is entered. The fingerprint-based deduplication management module 53 can determine whether the set of user data is the same as the any existing data at least according to whether the fingerprint (e.g. the at least one fingerprint of the at least one set of user data) matches any existing fingerprint among all of multiple existing fingerprints in the fingerprint storage.

For example, in a situation where a bit count of each of the multiple existing fingerprints is sufficient, the fingerprint-based deduplication management module 53 can determine whether the set of user data is the same as the any existing data according to whether the fingerprint matches the any existing fingerprint, wherein if the fingerprint matches the any existing fingerprint, the fingerprint-based deduplication management module 53 determines that the set of user data is the same as the any existing data, otherwise, the fingerprint-based deduplication management module 53 determines that the set of user data is not the same as any existing data in the storage device layer, but the present invention is not limited thereto. In addition, in a situation where the bit count of each of the multiple existing fingerprints is insufficient, the fingerprint-based deduplication management module 53 can further perform a byte-by-byte-compare (BBBC) operation when there is a need. For example, when the fingerprint matches the any existing fingerprint, which means it is possible that the set of user data can be found in the storage device layer, the fingerprint-based deduplication management module 53 can further perform the BBBC operation to determine whether the set of user data being the same as the any existing data is True, wherein if a BBBC comparison result of the BBBC operation indicates that the set of user data is found in the storage device layer, the fingerprint-based deduplication management module 53 determines that the set of user data being the same as the any existing data is True, otherwise, the fingerprint-based deduplication management module 53 determines that the set of user data being the same as the any existing data is False. For another example, when the fingerprint does not match any of the multiple existing fingerprints, which means it is impossible that the set of user data can be found in the storage device layer, the fingerprint-based deduplication management module 53 can determine that the set of user data being the same as the any existing data is False.

In Step S06A, in response to the aforementioned at least one set of user data being the same as the any existing data, the storage server 10 can perform deduplication. For example, a Volume Manager (VM) module among the program modules 52P running on the processing circuit 52 can create and store linking information (e.g. a soft link or a hard link pointing toward the existing data) of the set of user data into the storage device layer of the storage server 10, rather than storing the set of user data that is the same as the existing data into the storage device layer again. As a result, when receiving a read request of the set of user data (e.g. a request for reading the set of user data) in the future, the storage server 10 (e.g. the VM module) can obtain the existing data from the storage device layer according to the linking information of the set of user data, and return the existing data as the set of user data.

In Step S07A, in response to the aforementioned at least one set of user data being not the same as the any existing data, the storage server 10 (e.g. the VM module) can write the aforementioned at least one set of user data into the storage device layer.

In Step S08A, in response to the accessing request being not the write request, the storage server 10 can perform other processing. For example, when the accessing request is a read request, the storage server 10 can read data in response to the read request.

In Step S02B, the storage server 10 can utilize the command-related filter within the fingerprint-based deduplication management module 53 to monitor multiple commands at a processing path among multiple processing paths within the fingerprint-based deduplication management module 53.

In Step S03B, based on at least one predetermined rule (e.g. one or more predetermined rules) the storage server 10 can utilize the command-related filter to determine a set of commands regarding user-data change among the multiple commands at least according to addresses respectively carried by the set of commands, where a command count of the set of commands can be greater than or equal to two. For example, any address of these addresses, such as an address carried by one of the set of commands, can be a logical block address (LBA) sent from the client device of the user to the storage server 10, and therefore can be regarded as a user input LBA. For better comprehension, the at least one predetermined rule may comprise: when the addresses respectively carried by the set of commands are the same address and a first command of the set of commands requests deleting a corresponding set of user data at the same address first, all of one or more remaining commands of the set of commands are unnecessary, wherein when the command count of the set of commands is equal to two, there should be only one remaining command (e.g. the set of commands comprise the first command and the only one remaining command), otherwise, when the command count of the set of commands is greater than two, there should be multiple remaining commands (e.g. the set of commands comprise the first command and the multiple remaining commands); but the present invention is not limited thereto.

In Step S04B, the storage server 10 can utilize the command-related filter to convert the set of commands into a single command to eliminate one or more unnecessary commands among the set of commands, for executing the single command rather than all of the set of commands, thereby further enhancing the overall performance of the storage server 10. For example, when the addresses respectively carried by the set of commands are the same address and the first command of the set of commands requests deleting the corresponding set of user data at the same address first, all of the one or more remaining commands of the set of commands are unnecessary, where the single command and the one or more unnecessary commands may respectively represent the first command and the one or more remaining commands in this situation.

For better comprehension, the method may be illustrated with the working flow shown in FIG. 2, but the present invention is not limited thereto. According to some embodiments, one or more steps may be added, deleted, or changed in the working flow shown in FIG. 2.

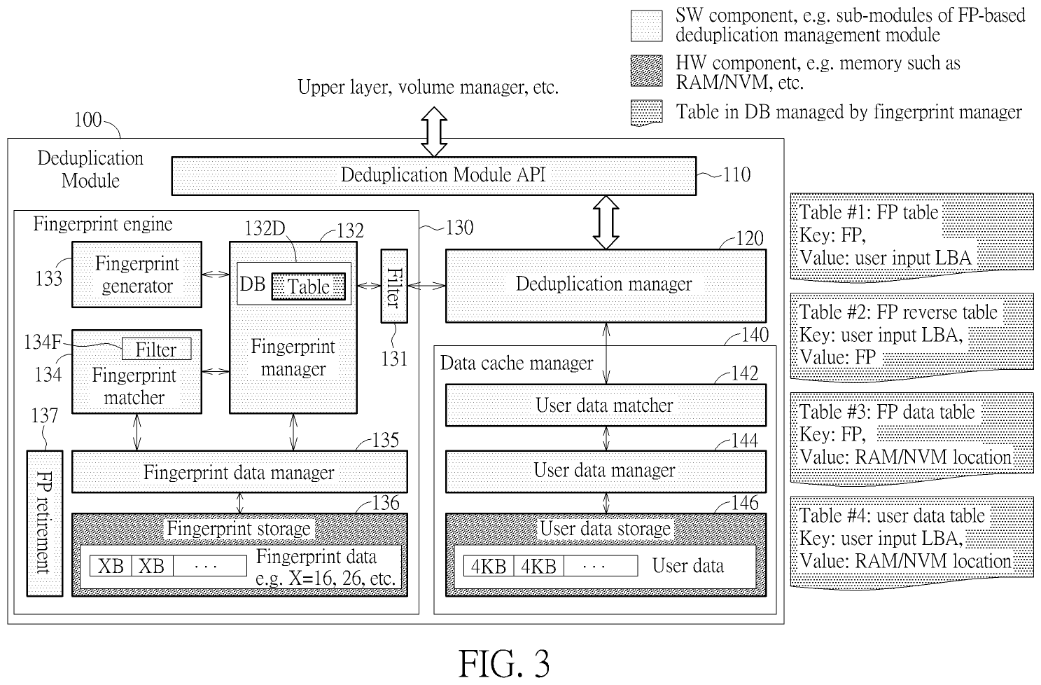

FIG. 3 illustrates a fingerprint (FP)-based deduplication control scheme of the method shown in FIG. 2 according to an embodiment of the present invention. As shown in FIG. 3, the storage server 10 can be configured to comprise a deduplication module 100, and the deduplication module 100 may comprise some software (SW) components some hardware (HW) components. The hardware components can be implemented by way of memory such as RAM/Non-Volatile Memory (NVM), etc. For better comprehension, the fingerprint-based deduplication management module 53 shown in FIG. 1 may comprise multiple sub-modules such as the software (SW) components shown in FIG. 3, where a filter 131 among these software components can be taken as an example of the command-related filter mentioned above, but the present invention is not limited thereto. In addition to the command-related filter such as the filter 131, the multiple sub-modules of the fingerprint-based deduplication management module 53 may further comprise a deduplication module application programming interface (API) 110, a deduplication manager 120, a fingerprint manager 132, a fingerprint generator 133, a fingerprint matcher 134, a fingerprint data manager 135, a fingerprint retirement module 137 (labeled “FP retirement” for brevity), a user data matcher 142, and a user data manager 144. The fingerprint matcher 134 may comprise a dedicated filter such as a filter 134, which is an internal filter of the fingerprint matcher 134, and can be implemented by way of Bloom filter. As shown in FIG. 3, the filter 131 can be illustrated outside the fingerprint manager 132, but the present invention is not limited thereto. For example, the filter 131 can be integrated into the fingerprint manager 132.

The deduplication module 100 may comprise a fingerprint engine 130 and a data cache manager 140. Each of the fingerprint engine 130 and the data cache manager 140 can be implemented by way of SW and HW components. The fingerprint engine 130 comprises a set of SW components such as the fingerprint manager 132, the fingerprint generator 133, the fingerprint matcher 134, the fingerprint data manager 135 and the fingerprint retirement module 137, and further comprises at least one HW component such as a fingerprint storage 136, which can be taken as an example of the fingerprint storage mentioned in Step S02A. The data cache manager 140 comprises a set of SW components such as the user data matcher 142 and the user data manager 144, and further comprises at least one HW component such as a user data storage 146. Each of the fingerprint storage 136 and the user data storage 146 can be implemented with a storage region of a storage-related hardware component under control of the fingerprint-based deduplication management module 53. For example, the storage-related hardware component may comprise any of a RAM, a NVM, an HDD, and an SSD. In addition, the deduplication module 100 can operate according to multiple tables in a database (DB) 132D managed by the fingerprint manager 132. The multiple tables may comprise one or more sets of Key-Value (KV) tables, and each set of KV table among the one or more sets of KV tables may comprise Tables #1, #2, etc. For example, Table #1 can be a fingerprint table, where the Key and the Value thereof may represent fingerprint (FP) and LBA such as user input LBA, respectively; Table #2 can be a fingerprint reverse table, where the Key and the Value thereof may represent LBA such as user input LBA and fingerprint (FP), respectively; Table #3 can be a fingerprint data table, where the Key and the Value thereof may represent fingerprint (FP) and RAM/NVM location (e.g. memory address of RAM/NVM), respectively; and Table #4 can be a user data table, where the Key and the Value thereof may represent LBA such as user input LBA and RAM/NVM location (e.g. memory address of RAM/NVM), respectively.

The deduplication module API 110 can interact with one or more other program modules outside the fingerprint-based deduplication management module 53 among the program modules 52P, such as the VM module, to receive at least one portion (e.g. a portion or all) of the multiple commands mentioned in Step S02B. For example, in a situation where the multiple commands comprise one or more internal commands of the deduplication module 100, the aforementioned at least one portion of the multiple commands may represent a portion of the multiple commands. For another example, in a situation where the multiple commands comprise commands from outside of the deduplication module 100, rather than any internal command of the deduplication module 100, the aforementioned at least one portion of the multiple commands may represent all of the multiple commands. In addition, the deduplication manager 120 can perform deduplication management by controlling associated operations of the deduplication module 100, for example, trigger the fingerprint engine 130 to perform fingerprint comparison and selectively trigger the data cache manager 140 to perform the BBBC operation, for generating a resultant comparison result (e.g. the resultant comparison result indicating whether the set of user data is the same as the any existing data) to be the determination result of Step S05A, to allow the storage server 10 (e.g. the VM module) to determine whether to perform deduplication. The deduplication module 100 (e.g. the deduplication manager 120, through the deduplication module API 110) can return the resultant comparison result to the VM module. When the resultant comparison result indicates that the set of user data is the same as the any existing data, the VM module can perform deduplication as mentioned in Step S06A, to save the storage capacity of the storage device layer; otherwise, the VM module can write the aforementioned at least one set of user data into the storage device layer as mentioned in Step S07A.

The fingerprint manager 132 can perform fingerprint management for the deduplication manager 120, for example, perform the fingerprint management in response to the single command rather than all of the set of commands, to control the fingerprint generator 133, the fingerprint matcher 134 and the fingerprint data manager 135 to operate correspondingly. The fingerprint generator 133 can perform fingerprint calculations on the multiple sets of user data and one or more subsequent sets of user data to generate corresponding calculation results as the multiple fingerprints and one or more subsequent fingerprints, respectively, for being stored into the fingerprint storage 136 and/or performing fingerprint comparison. In addition, the fingerprint matcher 134 can perform fingerprint comparison regarding fingerprint matching detection (e.g. detecting whether a fingerprint of a certain set of user data matches an existing fingerprint, for determining whether performing deduplication on this set of user data is required) to generate a fingerprint comparison result, and send the fingerprint comparison result to the fingerprint manager 132, for being returned to the deduplication manager 120. Additionally, the fingerprint retirement module 137 can manage fingerprint retirement, to remove one or more fingerprints when there is a need. Regarding controlling HW resources such as the HW components, the fingerprint data manager 135 can manage the fingerprint storage 136 for the fingerprint engine 130, and more particularly, perform fingerprint data management on the fingerprint storage 136 to write, read or delete a fingerprint when there is a need, and the user data manager 144 can manage the user data storage 146 for the data cache manager 140, and more particularly, perform user data management on the user data storage 146 to write, read or delete a set of user data when there is a need.

Based on the architecture shown in FIG. 3, the deduplication manager 120 can send the aforementioned at least one portion of the multiple commands to the command-related filter such as the filter 131, and the command-related filter such as the filter 131 can monitor the multiple commands, for example, collect (e.g. queue) and filter the multiple commands, to determine the set of commands and convert the set of commands into the single command, for being processed by the fingerprint manager 132. In addition, the deduplication manager 120 can utilize the fingerprint engine 130 to perform at least one portion (e.g. a portion or all) of the operation of Step S05A, and, upon user setting and/or default setting, selectively utilize the data cache manager 140 to perform a portion of the operation of Step S05A. When there is a need, the data cache manager 140 can be configured to cache at least one portion (e.g. a portion or all) of the multiple sets of user data and cache the one or more subsequent sets of user data in the user data storage 146, for performing the BBBC operation.

For better comprehension, assume that the cached user data (e.g. the at least one portion of the multiple sets of user data, as well as the one or more subsequent sets of user data) in the user data storage 146 can be cached in unit of 4 kilobytes (KB), and that the fingerprint data of the multiple existing fingerprints in the fingerprint storage 136 can be stored in unit of X bytes (B), which means the bit count of each of the multiple existing fingerprints is equal to 8× such as (8*X). For example, in a situation where the bit count 8× of each of the multiple existing fingerprints is sufficient (e.g. X=26, which means 8×=(8*26)=208), the deduplication module 100 can utilize the fingerprint engine 130 to determine whether the set of user data is the same as the any existing data according to whether the fingerprint matches the any existing fingerprint, having no need to utilize the data cache manager 140 to perform the BBBC operation (e.g. for double-checking the correctness of this determination). In addition, in a situation where the bit count 8× of each of the multiple existing fingerprints is insufficient (e.g. X=16, which means 8×=(8*16)=128), deduplication module 100 can selectively utilize the data cache manager 140 to perform the BBBC operation, for double-checking the correctness of this determination.

For example, when the fingerprint comparison result returned from the fingerprint engine 130 (e.g. the fingerprint manager 132) indicates that the fingerprint matches the any existing fingerprint, which means it is possible that the set of user data can be found in the storage device layer, the deduplication module 100 (e.g. the deduplication manager 120) can trigger the data cache manager 140 to perform the BBBC operation to determine whether the set of user data being the same as the any existing data is True. The data cache manager 140 (e.g. the user data matcher 142) can perform the BBBC operation to generate a comparison result, where the comparison result may indicate whether the set of user data is found in the storage device layer. If the comparison result of the BBBC operation indicates that the set of user data is found in the storage device layer, the data cache manager 140 (e.g. the user data matcher 142) can determine that the set of user data being the same as the any existing data is True, otherwise, the data cache manager 140 (e.g. the user data matcher 142) can determine that the set of user data being the same as the any existing data is False. For another example, when the fingerprint comparison result returned from the fingerprint engine 130 (e.g. the fingerprint manager 132) indicates that the fingerprint does not match any of the multiple existing fingerprints, which means it is impossible that the set of user data can be found in the storage device layer, the deduplication module 100 (e.g. the deduplication manager 120) can determine that the set of user data being the same as the any existing data is False, having no need to trigger the data cache manager 140 (e.g. the user data matcher 142) to perform the BBBC operation.

According to some embodiments, the processing circuit 52 may comprise the at least one processor/processor core and the associated circuits such as RAM, NVM, etc., but the present invention is not limited thereto. In some embodiments, the NVM can be implemented as a detachable NVM module within the host device 50 and coupled to the processing circuit 52.

Some implementation details regarding the deduplication module 100 can be described as follows. According to some embodiments, the fingerprint generator 133 can generate a fingerprint of a block data such as 4 KB data, and can be called by the fingerprint manage 132 through a fingerprint calculation function cal_fingerprint( ) as follows:

cal_fingerprint(char*data, int32_t data_len, callback function, callback arg);
where “char*data” in the above function is directed to the content of the block data, “int32_t data_len” represents the data length (e.g. 4K) of the block data, and “callback function” and “callback arg” represent a callback function and one or more callback arguments. In addition, a filter 134F within the fingerprint matcher 134 can be implemented with a Bloomer filter. The fingerprint matcher 134 equipped with the filter 134F such as the Bloomer filter can maintain some kind of indexing in memory (e.g. RAM/NVM) and provide API for the fingerprint manager 132 to query. If miss, the fingerprint matcher 134 can return miss; if hit, the fingerprint matcher 134 can return the matched fingerprint and the LBA of matched fingerprint. Additionally, the fingerprint data manager 135 can manage memory or disk space of the fingerprint storage 136, for storing the multiple fingerprints the one or more subsequent fingerprints, and removing the one or more fingerprints when there is a need. The fingerprint data manager 135 can provide API for the fingerprint manager 132 to access (e.g. write, read, trim, etc.) fingerprints. Regarding fingerprint retirement management, the fingerprint (FP) retirement module 137 can provide a mechanism to kick (e.g. remove or delete) an oldest or coldest fingerprint among all fingerprints in the fingerprint storage 136. Furthermore, the fingerprint manager 132 can manage and control the fingerprint generator 133, the fingerprint matcher 134, the fingerprint data manager 135 and the fingerprint retirement module 137 to provide fingerprint lookup services. The fingerprint manager 132 can make a decision about which LBA's fingerprint should be kept. The fingerprint manager 132 can maintain the multiple tables such as Tables #1, #2, etc., where the API of the fingerprint manager 132 may comprise fingerprint lookup, fingerprint delete, fingerprint update, etc.

Regarding Table #1 such as the fingerprint table, the fingerprint manager 132 can store a KV set such as {Key: fingerprint, Value: user input LBAx} in this table according to a command carrying the LBA LBAx such as LBA(x). When fingerprint match, the fingerprint manager 132 can get another LBA LBAy such as LBA(y) from this table, for example, by determine which LBA LBAy has the same fingerprint as that of the LBA LBAx. Based on the LBA LBAy, the fingerprint manager 132 can read data from a local pool and do (e.g. perform) BBBC with input 4 KB data (e.g. the block data such as the 4 KB data) carried by the command. Please note that, in a situation where the bit count 8× of each of the multiple existing fingerprints is insufficient (e.g. X=16, which means 8×=(8*16)=128), a fingerprint may be shared by different LBAs with different 4 KB data. A design option may be selected to decide the number of LBAs sharing one fingerprint, and more particularly, whether one or more LBAs share one fingerprint. For example, in a situation where the bit count 8× of each of the multiple existing fingerprints is sufficient (e.g. X=26, which means 8×=(8*26)=208), the fingerprint manager 132 can establish one-to-one mapping relationships between LBAs and fingerprints. Regarding Table #2 such as the fingerprint reverse table, the fingerprint manager 132 can store a KV set such as {Key: LBA, Value: fingerprint} in this table, for removing and updating the fingerprint. Regarding Table #3 such as the fingerprint data table, the fingerprint manager 132 can store a KV set such as {Key: fingerprint, Value: memory location or disk location} in this table, for indicating which memory location (e.g. RAM/NVM location) or which disk location to store a new fingerprint, or for querying or deleting an existing fingerprint. Regarding Table #4 such as the user data table, the fingerprint manager 132 can store a KV set such as {Key: LBA, Value: memory location or disk location} in this table, for indicating which memory location (e.g. RAM/NVM location) or which disk location to store a new set of user data, or for querying or deleting an existing set of user data.

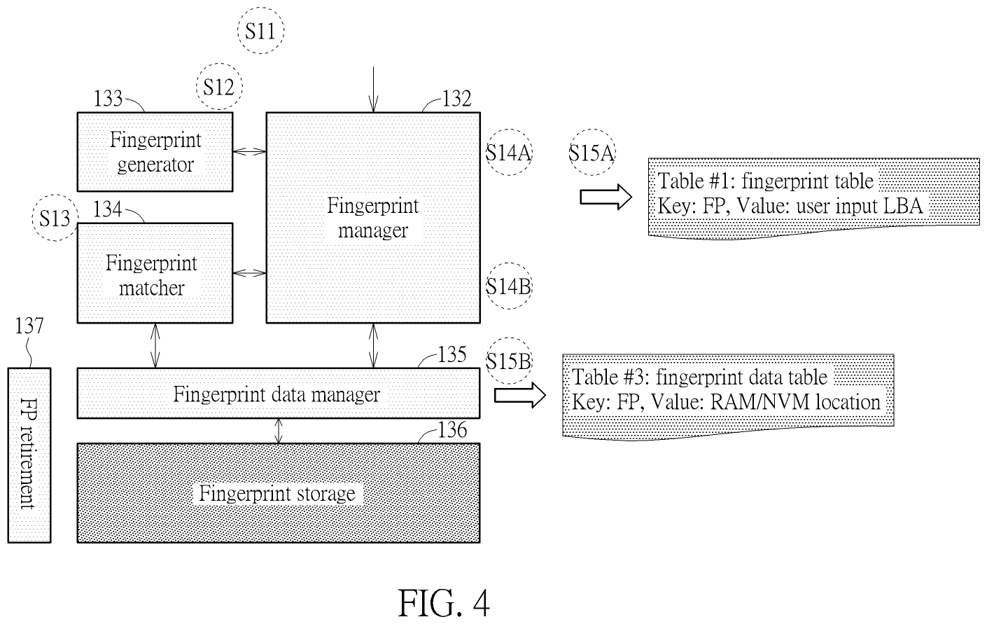

FIG. 4 illustrates a fingerprint lookup control scheme of the method shown in FIG. 2 according to an embodiment of the present invention.

In Step S11, the fingerprint manager 132 can perform fingerprint lookup, for example, by calling a fingerprint lookup function fp_lookup( ) as follows:

fp_lookup(4 KB data, LBA);
where “4 KB data” and “LBA” in the above function may represent a set of user data (e.g. the block data) and an associated LBA carried by a command, respectively.

In Step S12, the fingerprint generator 133 can calculate a fingerprint according to the 4 KB data.

In Step S13, the fingerprint matcher 134 can try finding a matched fingerprint in the fingerprint storage 136, and more particularly, determine whether any existing fingerprint among all existing fingerprints in the fingerprint storage 136 matches the fingerprint of the 4 KB data (e.g. the fingerprint that is just generated by the fingerprint generator 133 in Step S12). If Yes, it is a match-success case such as Case B(1); if No, it is a match-fail case such as Case A(1).

For better comprehension, the fingerprint manager 132 can use the DB 132D (e.g. Tables #1, #2, etc.) to cache (e.g. temporarily store) at least one portion of fingerprints among all existing fingerprints into the fingerprint storage 136, for accelerating the operation of Step S13. The fingerprint manager 132 can cache the portion of fingerprints and respective LBAs of corresponding sets of user data (e.g. these sets of user data represented by the portion of fingerprints) to be Keys and Values of multiple KV sets in Tables #1, respectively, and cache the respective LBAs of the corresponding sets of user data and the portion of fingerprints to be Keys and Values of multiple corresponding KV sets in Tables #2, respectively, and can further store the portion of fingerprints and memory/disk location of the portion of fingerprints (e.g. the memory/disk location in the fingerprint storage 136) to be Keys and Values of multiple corresponding KV sets in Table #3, respectively, to maintain the DB 132D, but the present invention is not limited thereto.

In Step S14A, in the match-fail case such as Case A(1), the fingerprint manager 132 can make a decision about whether to keep this fingerprint (e.g. the fingerprint mentioned in Step S12) in the DB 132D, for example, according to a least recently used (LRU) method, for saving the storage capacity of the DB 132D. If Yes (e.g. keeping the fingerprint is needed when the fingerprint belongs to hot fingerprints), the fingerprint manager 132 can control the fingerprint data manager 135 to save this fingerprint, and notify the data cache manager 140 (e.g. the user data manger 144) to save the 4 KB data; if No (e.g. keeping the fingerprint is not needed when the fingerprint belongs to cold fingerprints), the fingerprint manager 132 can reply the deduplication manager 120 with “no match” to indicate that no matched fingerprint can be found, to allow the deduplication manager 120 return the resultant comparison result corresponding to “no match” to the VM module through the deduplication module API 110, where the resultant comparison result corresponding to “no match” may indicate that the aforementioned at least one set of user data is not the same as the any existing data.

In Step S14B, in the match-success case such as Case B(1), the fingerprint manager 132 can return the matched LBA (e.g. the LBA of the any existing data) to the deduplication manager 120, to allow the deduplication manager 120 return the resultant comparison result corresponding to the matched LBA to the VM module through the deduplication module API 110, where the resultant comparison result corresponding to the matched LBA may indicate that the aforementioned at least one set of user data is the same as the any existing data.

In Step S15A, the fingerprint manager 132 can add or update at least one table such as Table #1 when there is a need. For example, when it is determined that keeping the fingerprint is needed, the fingerprint manager 132 can add this fingerprint (e.g. the fingerprint mentioned in Step S12) into the DB 132D and update the at least one table such as Table #1 correspondingly.

In Step S15B, the fingerprint data manager 135 can add or update at least one associated table such as Table #3 through the fingerprint manager 132 when there is a need. For example, when it is determined that keeping the fingerprint is needed, the fingerprint data manager 135 can store this fingerprint (e.g. the fingerprint mentioned in Step S12) into the fingerprint storage 136, and return the memory/disk location in the fingerprint storage 136 to the fingerprint manager 132, for adding this fingerprint (e.g. the fingerprint mentioned in Step S12) into the DB 132D and updating the at least one associated table such as Table #3 correspondingly.

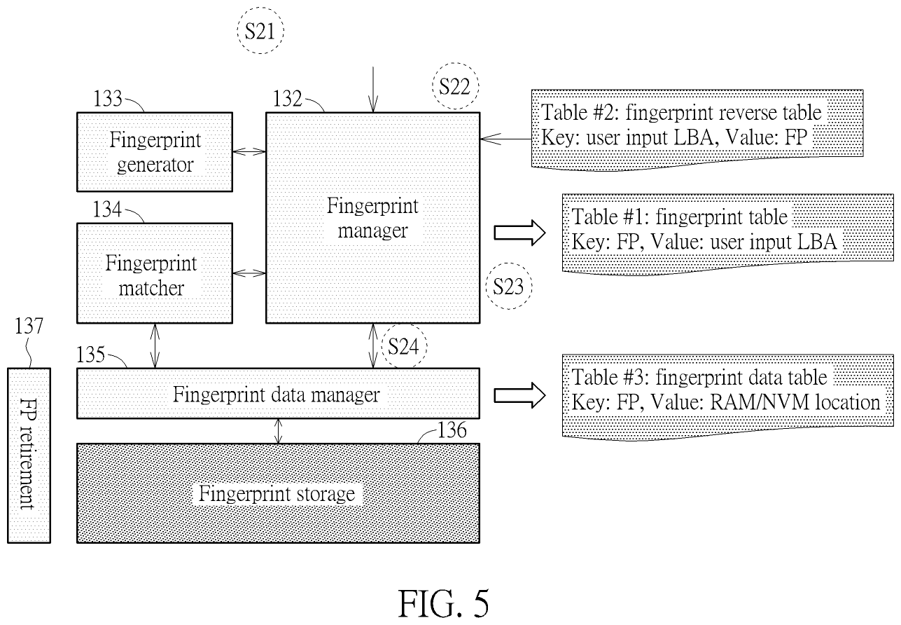

FIG. 5 illustrates a fingerprint delete control scheme of the method shown in FIG. 2 according to an embodiment of the present invention.

In Step S21, the fingerprint manager 132 can perform fingerprint deletion, for example, by calling a fingerprint deletion function fp_delete( ) as follows:

fp_delete(LBA);
where “LBA” in the above function may represent an associated LBA carried by a command.

In Step S22, the fingerprint manager 132 can query Table #2 and delete an entry corresponding to this LBA (e.g. the LBA carried by the command) in Table #2, such as a KV set in which the Key thereof is equal to this LBA.

In Step S23, the fingerprint manager 132 can delete a corresponding entry in Table #1, such as a KV set in which the Value thereof is equal to this LBA (e.g. the LBA carried by the command).

In Step S24, the fingerprint manager 132 can control the fingerprint data manager 135 to remove the fingerprint corresponding to this LBA (e.g. the LBA carried by the command) from the fingerprint storage 136, and delete a corresponding entry in Table #3, such as a KV set storing this fingerprint and the memory/disk location of this fingerprint.

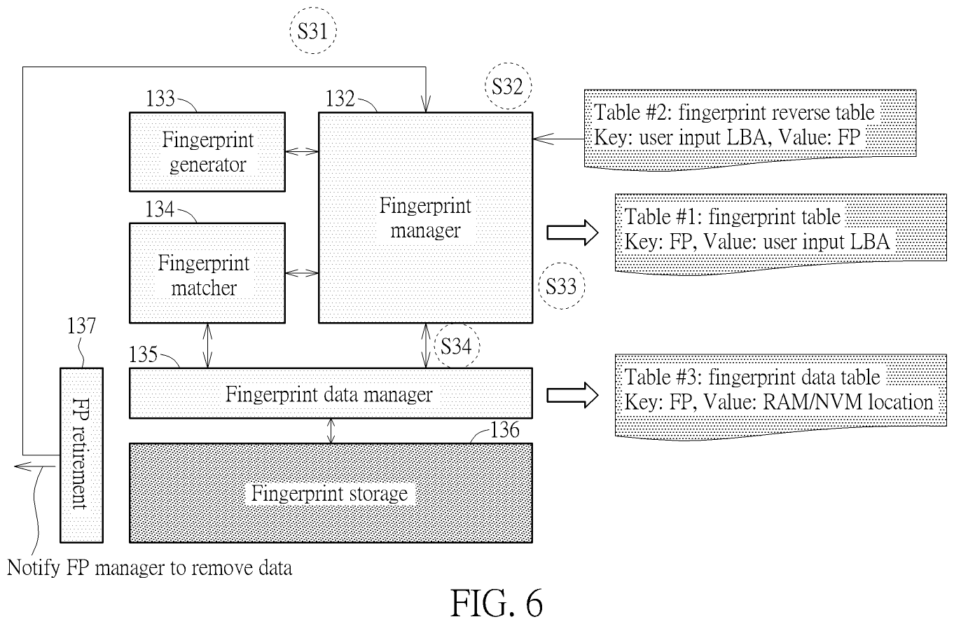

FIG. 6 illustrates a fingerprint retirement control scheme of the method shown in FIG. 2 according to an embodiment of the present invention.

In Step S31, the FP retirement module 137 can trigger fingerprint retirement, and more particularly, notify the fingerprint manager 132 to remove data (e.g. fingerprint data) of a certain fingerprint, for example, by calling the fingerprint deletion function fp_delete( ) as follows:

fp_delete(LBA);
where “LBA” in the above function may represent an associated LBA corresponding to this fingerprint.

In Step S32, the fingerprint manager 132 can query Table #2 and delete an entry corresponding to this LBA (e.g. the LBA corresponding to this fingerprint) in Table #2, such as a KV set in which the Key thereof is equal to this LBA.

In Step S33, the fingerprint manager 132 can delete a corresponding entry in Table #1, such as a KV set in which the Value thereof is equal to this LBA (e.g. the LBA corresponding to this fingerprint).

In Step S34, the fingerprint manager 132 can control the fingerprint data manager 135 to remove this fingerprint from the fingerprint storage 136, and delete a corresponding entry in Table #3, such as a KV set storing this fingerprint and the memory/disk location of this fingerprint.

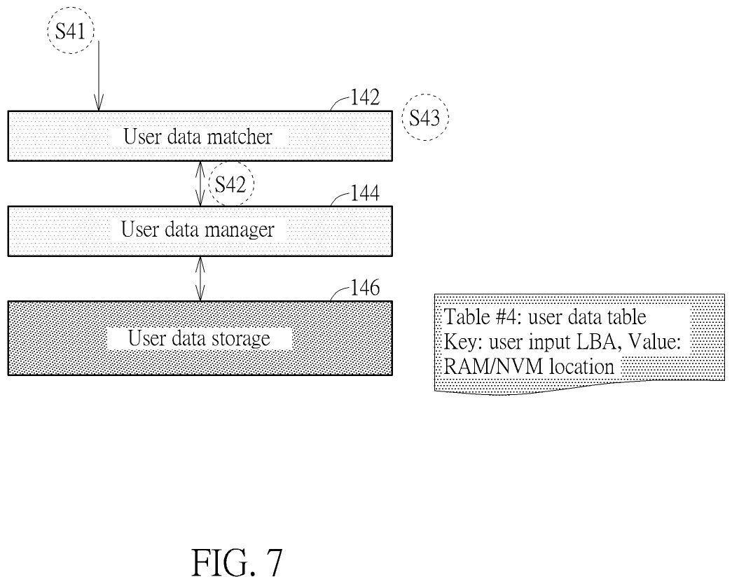

FIG. 7 illustrates a byte-by-byte-compare (BBBC) control scheme of the method shown in FIG. 2 according to an embodiment of the present invention.

In Step S41, the user data matcher 142 can perform the BBBC operation, for example, by calling a do-BBBC function do_bbbc( ) as follows:

do_bbbc(user input LBAx, user input data, LBAy got from fingerprint engine);
where “user input LBAx” and “user input data” in the above function may represent an LBA LBAx (e.g. LBA(x)) and a set of user data that are carried by a command, respectively, and “LBAy got from fingerprint engine” in the above function may represent an LBA LBAy (e.g. LBA(y)) got from the fingerprint engine 130 (e.g. the fingerprint manager 132) through the deduplication manager 120 when the BBBC is triggered. The data size of this set of user data is 4 KB.

In Step S42, based on Table #4, the user data matcher 142 can control the user data manager 144 to read 4 KB data associated with the LBA LBAy (e.g. a cached version of existing 4 KB data stored at the LBA LBAy) from the user data storage 146 according to the LBA LBAy.

In Step S43, the user data matcher 142 can perform the BBBC operation, for example, compare this set of user data (e.g. the set of user data carried by the command) with the 4 KB data associated with the LBA LBAy (e.g. the 4 KB data that is just read from the user data storage 146 in Step S42) in a byte-by-byte manner to generate the BBBC comparison result to be the resultant comparison result. The BBBC comparison result can indicate whether this set of user data is exactly the same as the 4 KB data associated with the LBA LBAy. If Yes, it is a hit case such as Case A(2); if No, it is a miss case such as Case B(2). For example, in the hit case such as Case A(2), the user data matcher 142 can reply the fingerprint manager 132 with the BBBC comparison result corresponding to “hit” to indicate that this set of user data is exactly the same as the 4 KB data associated with the LBA LBAy; and in the miss case such as Case B(2), the user data matcher 142 can reply the fingerprint manager 132 with the BBBC comparison result corresponding to “miss” to indicate that this set of user data is not exactly the same as the 4 KB data associated with the LBA LBAy; but the present invention is not limited thereto. For another example, in the hit case such as Case A(2), the user data matcher 142 can return the BBBC comparison result corresponding to “hit” to the deduplication manager 120, for indicating that this set of user data is exactly the same as the 4 KB data associated with the LBA LBAy; and in the miss case such as Case B(2), the user data matcher 142 can return the BBBC comparison result corresponding to “miss” to the deduplication manager 120, for indicating that this set of user data is not exactly the same as the 4 KB data associated with the LBA LBAy.

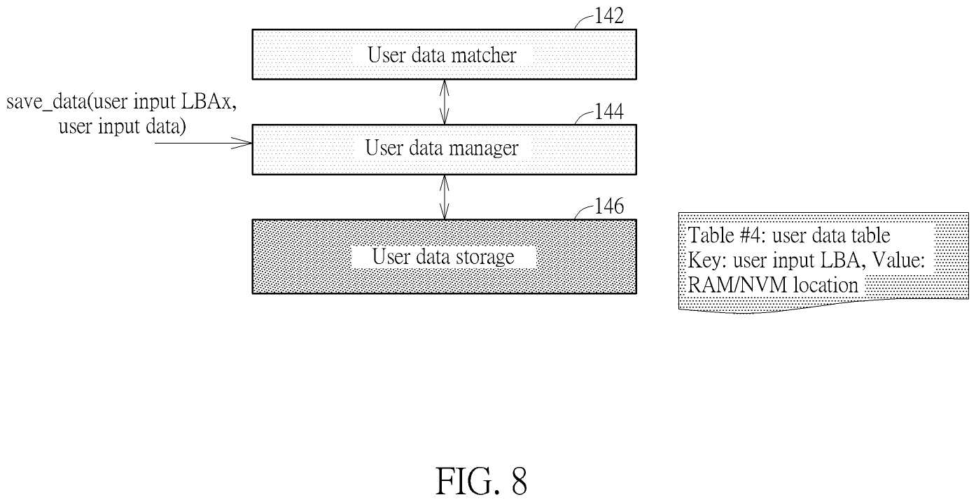

FIG. 8 illustrates a save data control scheme of the method shown in FIG. 2 according to an embodiment of the present invention. When deciding to save a fingerprint, such as the fingerprint of a set of user data carried by a command, the fingerprint engine 130 (e.g. the fingerprint manager 132) can notify the user data manager 144, for example, by calling a save data function save_data( ) as follows:

save_data(user input LBAx, user input data);
where “user input LBAx” and “user input data” in the above function may represent an associated LBA LBAx (e.g. LBA(x)) and the set of user data that are carried by the command, respectively. In addition, the fingerprint manager 132 can update Table #4 correspondingly for the user data manager 144.

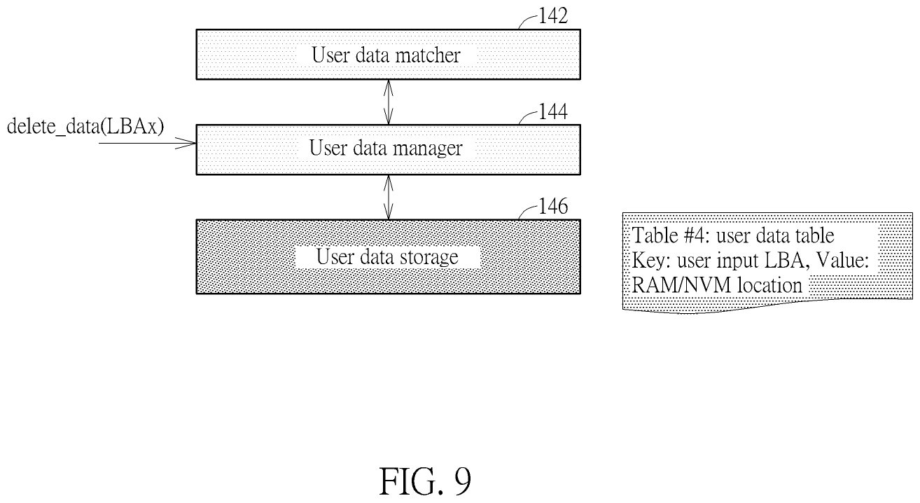

FIG. 9 illustrates a delete data control scheme of the method shown in FIG. 2 according to an embodiment of the present invention. For example, when the user determines to trim data at one or more addresses, such as a set of data at the LBA LBAx (e.g. LBA(x)), the deduplication manager 120 can delete a cached version of this set of data in the user data storage 146 by calling a data deletion function delete_data( ) as follows:

delete_data(LBAx);
where the fingerprint manager 132 can update Table #4 correspondingly for the deduplication manager 120, but the present invention is not limited thereto. For another example, when the fingerprint engine 130 (e.g. the fingerprint retirement module 137) decides that retirement of a fingerprint is required and the fingerprint is a fingerprint of a set of data at the LBA LBAy (e.g. LBA(y)), the fingerprint engine 130 (e.g. the fingerprint manager 132) can trigger deletion of a cached version of this set of data in the user data storage 146 by calling the data deletion function delete_data( ) as follows:
delete_data(LBAy);
where the fingerprint manager 132 can update Table #4 correspondingly.

According to some embodiments, the storage server 10 can be equipped with a high availability (HA) architecture. For better comprehension, the architecture shown in FIG. 1 can be changed (e.g. upgraded) to comprise multiple processing circuits {52} running respective program modules {52P}, and the multiple processing circuits {52} running respective program modules {52P} can act as multiple nodes within the HA architecture, respectively. For example, a first node and a second node among the multiple nodes can play the role of an active node and the role of a standby node by default, respectively. The active node can control the storage server 10 to provide services to the one or more users, and the standby node can be regarded as a backup node of the active node. When the active node malfunctions, the standby node can be triggered to become the latest active node to control the storage server 10, for continuing providing the services to the one or more users. In addition, the at least one storage interface circuit 54 and the network interface circuit 58 can be changed correspondingly, to provide connection paths from the multiple nodes to these circuits, respectively, and more particularly, have switching capability regarding the connection paths, to allow the multiple nodes to operate independently, but the present invention is not limited thereto.

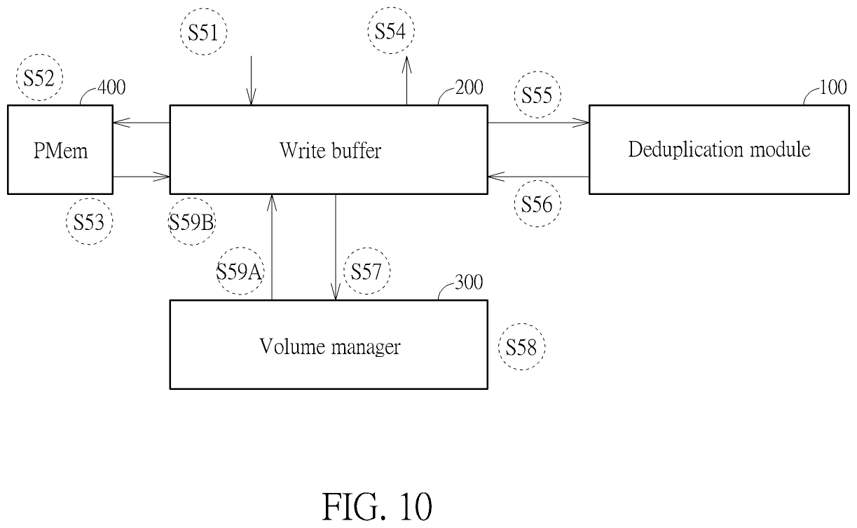

FIG. 10 illustrates an accessing control scheme of the method shown in FIG. 2 according to an embodiment of the present invention. For example, in a situation where the storage server 10 shown in FIG. 1 is equipped with the HA architecture, the processing circuits 52 running the program modules 52P can be regarded as the active node, and a replica of the processing circuits 52 running the program modules 52P can be regarded as the standby node, but the present invention is not limited thereto. In addition, any node (e.g. each node) of the active node and the standby node can be equipped with an important information protection system, for protecting important information such as system information, buffered data, etc. in at least one volatile memory (e.g. one or more RAMs such as DRAMs) of the any node. The important information protection system may comprise the at least one volatile memory, a backup power unit (e.g. battery) and a backup storage (e.g. NVM, SSD, etc.), for performing backup on the important information when there is a need, where the backup power unit is capable of providing backup power to the at least one volatile memory and the backup storage. For example, when power failure of a main power of the any node occurs, the important information protection system can use the backup power unit to prevent loss of the important information, and use the backup storage to store the important information.

In response to a write request of the user, a Write Buffer (WB) module among the program modules 52P running on the processing circuit 52, such as the write buffer 200 shown in FIG. 10, can control some other modules (e.g. SW module, HW module, and/or hybrid module comprising sub-modules such as SW and HW modules) to perform data writing. Under control of a Persistent Memory (PMem) module among the program modules 52P running on the processing circuit 52, such as the PMem 400 shown in FIG. 10, the active node can send buffered data (e.g. data to be written into the storage device layer of the storage server 10, in response to the write request) to the standby node through at least one communications connection path between the active node and the standby node, and utilize at least one portion (e.g. a portion or all) of the standby node as an emulated persistent memory of the active node, where the emulated persistent memory such as the at least one portion of the standby node may comprise the important information protection system of the standby node. The volume manager 300 shown in FIG. 10 can be taken as examples of the Volume Manager (VM) module mentioned above.

In Step S51, in response to the write request of the user, an upper later above the write buffer 200, such as a User Interface (UI) module among the program modules 52P running on the processing circuit 52, can write data into the storage server 10, for example, by calling a write function write( ) as follows:

write(V1, volume LBAx, 4 KB data);
where “V1” and “volume LBAx” may represent a volume ID of a first volume (e.g. one of multiple virtual volumes obtained from the storage pool architecture) and a volume LBA LBAx (e.g. LBA(x)) in the first volume, respectively, and “4 KB data” may represent a set of user data (e.g. the block data) within the data carried by the write request.

In Step S52, the PMem 400 can write the 4 KB data to the at least one volatile memory of the important information protection system of the active node and write the 4 KB data to the remote side such as the at least one volatile memory of the important information protection system of the standby node.

In Step S53, the PMem 400 can send an acknowledgement (Ack) to the write buffer 200.

In Step S54, the write buffer 200 can send an Ack to the user (e.g. the client device of the user) through the upper layer (e.g. the UI module) to indicate write OK (e.g. completion of writing).

In Step S55, the write buffer 200 can trigger a background thread regarding deduplication to pick the 4 KB data, for being sent to the deduplication module 100, for example, by calling the deduplication module API 110 with a deduplicate-me function deduplicate_me( ) as follows:

deduplicate_me(8B key, 4 KB data);
where “4 KB data” and “8B key” in the above function may represent the set of user data (e.g. the block data) and a 8 bytes (B) key of the set of user data, respectively. For example, the 8B key can be calculated as follows:
8B key=((volume ID<<32) volume LBA);
where “volume ID” and “volume LBA” for calculating the 8B key may represent the volume ID V1 and the volume LBA LBAx, respectively, and “<<” may represent a logical shift operator for left shift in C-family languages (e.g. (V1<<32) assigns the calculation result thereof to be the shifting result of shifting V1 to the left by 32 bits, which is equivalent to a multiplication by 2³²), but the present invention is not limited thereto. In this situation, the 8B key can be regarded as a combined virtual volume LBA (VVLBA) such as a combination (V1, LBAx) of the volume ID V1 and the volume LBA LBAx.

In Step S56, the deduplication module 100 can reply a result such as the resultant comparison result to the write buffer 200. The resultant comparison result can indicate whether the set of user data is exactly the same as the any existing data. If Yes, it is a hit case such as Case A(3); if No, it is a miss case such as Case B(3). For example, in the miss case such as Case B(3), the WB module such as the write buffer 200 (e.g. the background thread thereof) can call a compression engine in the active node and perform inline compression on the 4 KB data with the compression engine, for writing a compressed version of the 4 KB data into the storage device layer; and in the hit case such as Case A(3), the deduplication module 100 can return another 8B key such as a combination (V2, LBAy) of a volume ID V2 of a second volume among the multiple virtual volumes and a volume LBA LBAy (e.g. LBA(y)) in the second volume, for performing deduplication in the subsequent steps. For example, the second volume can be different from the first volume (e.g. the volume ID V2 is not equal to the volume ID V1), where it is unnecessary that the volume LBA LBAy is different from the volume LBA LBAx since they respectively belong to different volumes, but the present invention is not limited thereto. For another example, the second volume can be the same as the first volume (e.g. V2=V1), where the volume LBA LBAy is different from the volume LBA LBAx.

As the write buffer 200 can access (e.g. query) the deduplication module 100 with an 8B key (or VVLBA) such as (V1, LBAx) in Step S55 and can obtain, in the hit case, another 8B key (or VVLBA) such as (V2, LBAy) from the deduplication module 100 in Step S56, the write buffer 200 does not need to obtain an SLBA corresponding to the address (V1, LBAx) from the volume manager 300 before accessing (e.g. querying) the deduplication module 100, but the present invention is not limited thereto. In some embodiments, the write buffer 200 can obtain an SLBA corresponding to the address (V1, LBAx) from the volume manager 300 first, and access (e.g. query) the deduplication module 100 with the SLBA.

In Step S57, the write buffer 200 can control the volume manager 300 to copy or redirect metadata regarding the addresses (V2, LBAy) and (V1, LBAx), for example, by calling a metadata-redirect function metadata( ) as follows:

metadata(V2, LBAy, V1, LBAx);
where “V2, LBAy” and “V1, LBAx” in the above function may represent the source location and the destination location of metadata-redirect processing.

In Step S58, the volume manager 300 can execute the metadata-redirect function metadata( ) with some sub-steps such as Steps S58A-S58C.

In Step S58A, the volume manager 300 can perform VM lookup according to the address (V2, LBAy) to get an SLBA SLBA(1). For example, the storage server 10 (e.g. the volume manager 300) can establish and update a remapping table (e.g. SLBA-VVLBA remapping table) to record remapping relationships between SLBAs and VVLBAs with multiple entries of this remapping table, and the volume manager 300 can refer to this remapping table to perform the VM lookup, but the present invention is not limited thereto.

In Step S58B, the volume manager 300 can fill an entry (V1, LBAx, SLBA(1)) into another remapping table such as a deduplication remapping table. For example, the storage server 10 (e.g. the volume manager 300) can establish and update this remapping table (e.g. the deduplication remapping table) to record deduplication relationships between repeated user data (e.g. the set of user data) and existing user data (e.g. the any existing data) with multiple entries of this remapping table, and the volume manager 300 can use the entry (V1, LBAx, SLBA(1)) to record a deduplication relationship between a virtually stored version of the set of user data at the address (V1, LBAx) and the existing user data at the SLBA SLBA(1), where the linking information may represent the virtually stored version of the set of user data.

In Step S58C, the volume manager 300 can increase a reference count REFCNT in an entry (SLBA(1), REFCNT) regarding the SLBA SLBA(1) among multiple entries of a reference count table, for example, updating this entry of the reference count table as follows:

### (SLBA(1), REFCNT(1))→(SLBA(1), REFCNT(2));

where “REFCNT(1)” and “REFCNT(2)” may represent a previous value and a latest value of the reference count REFCNT, and REFCNT(2)=(REFCNT(1)+1). For example, if it is the first time that the existing user data at the SLBA SLBA(1) is found to match incoming data (e.g. the set of user data), REFCNT(1)=1 and REFCNT(2)=2, but the present invention is not limited thereto. In some embodiments, the reference count REFCNT can be equal to the number of logical addresses linking to the same SLBA such as SLBA(1).

In Step S59A, the volume manager 300 can send an Ack to the WB module such as the write buffer 200.

In Step S59B, the WB module such as the write buffer 200 can control the PMem 400 to remove cached data such as the 4 KB data of the address (V1, LBAx) from the PMem 400.

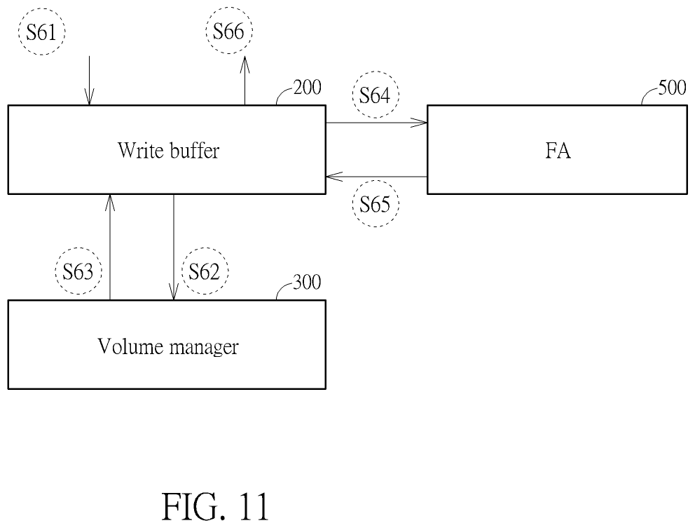

FIG. 11 illustrates a read data control scheme of the method shown in FIG. 2 according to an embodiment of the present invention. In response to a read request of the user, the WB module such as the write buffer 200 can control some other modules (e.g. SW module, HW module, and/or hybrid module comprising sub-modules such as SW and HW modules) to perform data reading. Under control of a Flash Array (FA) module among the program modules 52P running on the processing circuit 52, such as the FA 500 shown in FIG. 11, the storage server 10 can configure the storage device layer to be a Flash Array, and the WB module such as the write buffer 200 can access the storage device layer through the FA 500. For example, in a situation where all storage devices in the storage device layer are implemented with NVM devices such as SSDs, the Flash Array can be an All Flash Array (AFA), and therefore the storage server 10 can be regarded as an AFA server, but the present invention is not limited thereto.

In Step S61, in response to the read request of the user, the upper later such as the UI module can read data from the storage server 10, for example, by calling a read function read( ) as follows:

read(V1, volume LBAx);
where “V1” and “volume LBAx” may represent a volume ID of a first volume (e.g. one of the multiple virtual volumes obtained from the storage pool architecture) and a volume LBA LBAx (e.g. LBA(x)) in the first volume, respectively.

In Step S62, the write buffer 200 can control the volume manager 300 to query metadata of target data (e.g. the data to be read) at the address (V1, LBAx).

In Step S63, the volume manager 300 can return an associated SLBA such as an SLBA SLBA(1) corresponding to the address (V1, LBAx).

In Step S64, the write buffer 200 can read the target data at the SLBA SLBA(1) from the FA 500.

In Step S65, the FA 500 can return the target data to the write buffer 200.

In Step S66, the write buffer 200 can send an Ack to the user (e.g. the client device of the user) through the upper layer (e.g. the UI module) to indicate read OK (e.g. completion of reading).

According to some embodiments, the storage server 10 (e.g. the write buffer 200) can read data from the deduplication module 100. For example, if the storage device layer is implemented by way of backend storage (e.g. all NVMe SSDs) that is faster than any user data cache (e.g. the user data storage 146) in deduplication module 100, the storage server 10 can be configured to read data from the storage device layer since reading data from such backend storage is better. For another example, if the storage device layer is implemented by way of backend storage (e.g. Serial Attached SCSI (SAS)/SATA architecture comprising HDDs and/or SSDs) that is slower than the any user data cache (e.g. the user data storage 146) in the deduplication module 100, the storage server 10 can be configured to read data from the deduplication module 100 since reading data from the deduplication module 100 is better. More particularly, when the storage server 10 (e.g. the write buffer 200) calls the deduplication module 100 through the deduplication module API 110, for example, using the deduplicate-me function deduplicate_me( ), the deduplicate-me function deduplicate_me( ) may need to tell the caller (e.g. the write buffer 200) following things:

(1) hit or miss: no matter whether it is a hit case or a miss case, the deduplication module 100 can tell the caller whether there is one copy of the target data in the local cache thereof (e.g. the user data storage 146), wherein whether hit or miss is not the main concern here;
(2) whether the target data is in the deduplication module 100 or not.

In addition, when the deduplication module 100 returns that it has saved one copy of the target data in the local cache thereof (e.g. the user data storage 146), the write buffer 200 can notify the volume manager 300 to record the following read-related information:

(Volume ID, LBA, SLBA, whether a copy exists in deduplication module);
where “Volume ID” and “LBA” in the above information may represent a volume ID of a certain volume (e.g. one of the multiple virtual volumes obtained from the storage pool architecture) and a volume LBA in this volume, respectively, “SLBA” in the above information may represent an SLBA corresponding to the address (Volume ID, LBA), and “whether a copy exists in deduplication module” may represent an existence flag indicating whether there is a copy of the target data in deduplication module 100. For example, the volume manager 300 can refer to the SLBA-VVLBA remapping table to perform the VM lookup according to the address (Volume ID, LBA), for obtaining this SLBA.

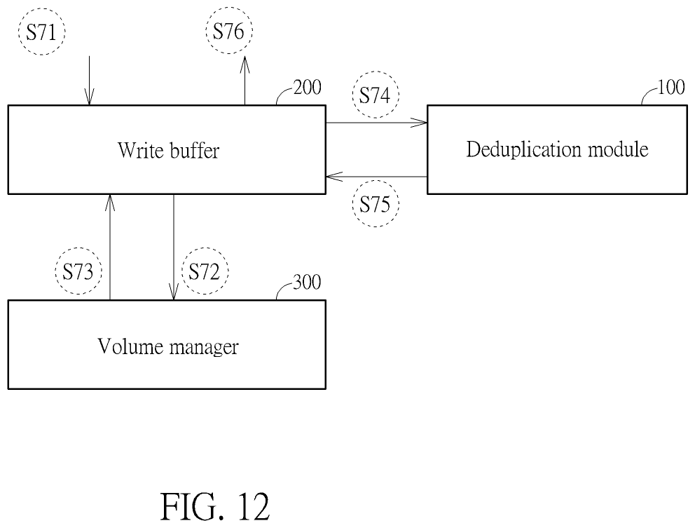

FIG. 12 illustrates a read data control scheme of the method shown in FIG. 2 according to another embodiment of the present invention, where the deduplication module 100 has the target data.

In Step S71, in response to the read request of the user, the upper later such as the UI module can read data from the storage server 10, for example, by calling the read function read( ) as follows:

read(V1, volume LBAx);
where “V1” and “volume LBAx” may represent the volume ID of the first volume (e.g. one of the multiple virtual volumes obtained from the storage pool architecture) and the volume LBA LBAx (e.g. LBA(x)) in the first volume, respectively.

In Step S72, the write buffer 200 can control the volume manager 300 to query metadata of the target data (e.g. the data to be read) at the address (V1, LBAx).

In Step S73, the volume manager 300 can return the existence flag corresponding to existence to the write buffer 200, for indicating that there is one copy in the deduplication module 100. For example, the volume manager 300 has recorded the read-related information such as (V1, volume LBAx, SLBA(1), whether a copy exists in deduplication module), and can obtain the SLBA SLBA(1) and the existence flag corresponding to existence from the read-related information, for being returned to the write buffer 200.

In Step S74, the write buffer 200 can read the target data at the SLBA SLBA(1) from the deduplication module 100.

In Step S75, the deduplication module 100 can return the target data to the write buffer 200.

In Step S76, the write buffer 200 can send an Ack to the user (e.g. the client device of the user) through the upper layer (e.g. the UI module) to indicate read OK (e.g. completion of reading).

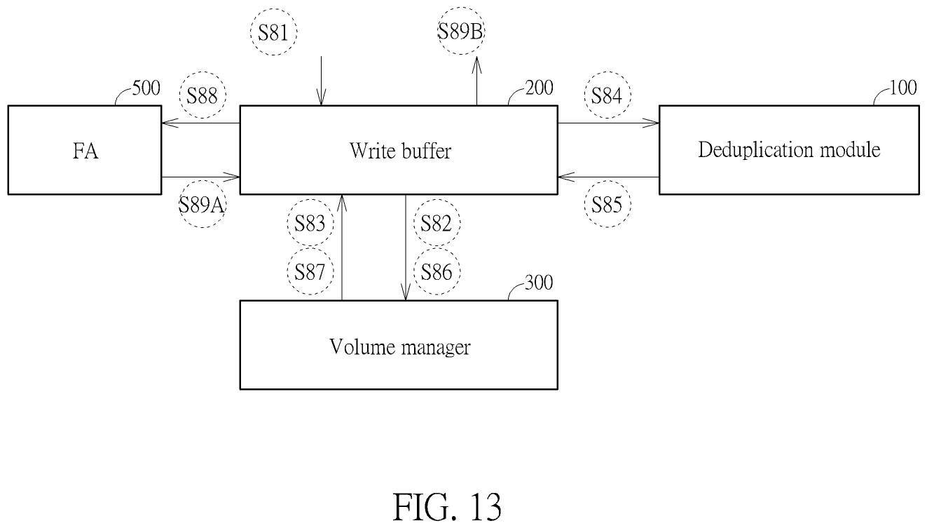

FIG. 13 illustrates a read data control scheme of the method shown in FIG. 2 according to yet another embodiment of the present invention, where the deduplication module 100 has previously stored the target data in the user data storage 146, but has already removed the target data (e.g. the deduplication module 100 is supposed to do so after triggering retirement of a corresponding fingerprint).

In Step S81, in response to the read request of the user, the upper later such as the UI module can read data from the storage server 10, for example, by calling the read function read( ) as follows:

read(V1, volume LBAx);
where “V1” and “volume LBAx” may represent the volume ID of the first volume (e.g. one of the multiple virtual volumes obtained from the storage pool architecture) and the volume LBA LBAx (e.g. LBA(x)) in the first volume, respectively.

In Step S82, the write buffer 200 can control the volume manager 300 to query metadata of the target data (e.g. the data to be read) at the address (V1, LBAx).

In Step S83, the volume manager 300 can return that there is one copy in the deduplication module 100.

In Step S84, the write buffer 200 can read the target data at the SLBA SLBA(1) from the deduplication module 100.

In Step S85, the deduplication module 100 can return with no data, for example, return null data as the target data to indicate that no existing data matches the target data.

In Step S86, the write buffer 200 can control the volume manager 300 to query metadata of the target data (e.g. the data to be read) at the address (V1, LBAx) again.

In Step S87, the volume manager 300 can return the SLBA SLBA(1) to the write buffer 200. For example, the volume manager 300 has recorded the read-related information such as (V1, volume LBAx, SLBA(1), whether a copy exists in deduplication module), and can obtain the SLBA SLBA(1) from the read-related information, for being returned to the write buffer 200.

In Step S88, the write buffer 200 can read the target data at the SLBA SLBA(1) from the FA 500.

In Step S89A, the FA 500 can return the target data to the write buffer 200.

In Step S89B, the write buffer 200 can send an Ack to the user (e.g. the client device of the user) through the upper layer (e.g. the UI module) to indicate read OK (e.g. completion of reading).

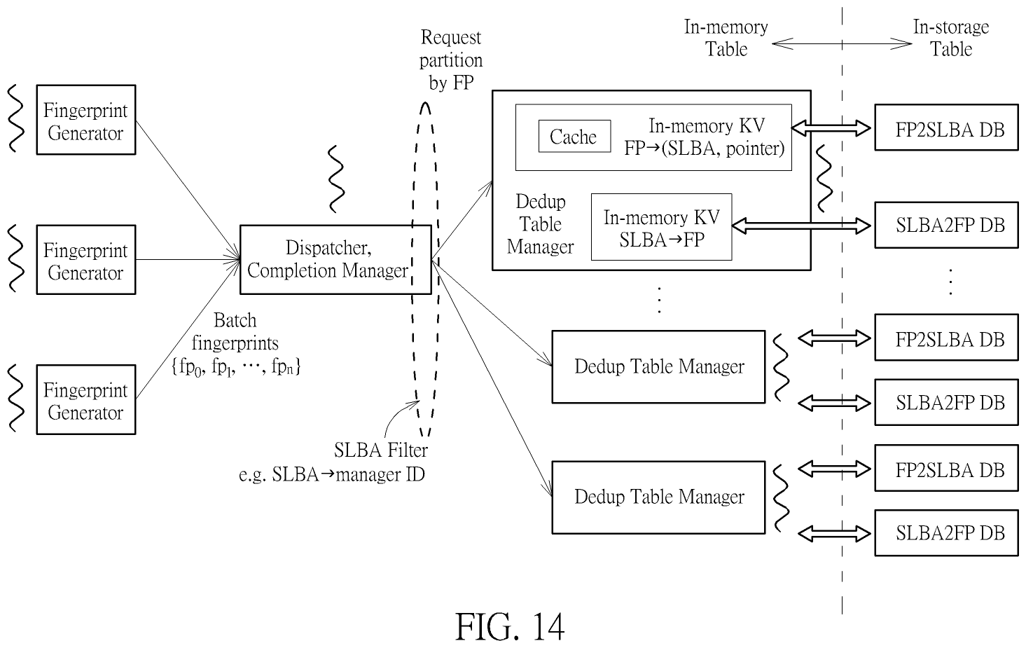

FIG. 14 illustrates a filtering and processing control scheme of the method shown in FIG. 2 according to an embodiment of the present invention. The fingerprint engine 130 shown in FIG. 3 (e.g. the SW components therein) can operate according to the filtering and processing control scheme shown in FIG. 14. For better comprehension, the fingerprint manager 132 in the fingerprint engine 130 may comprise a dispatcher and multiple deduplication (Dedup) table managers, the fingerprint generator 133 that operates under control of the fingerprint manager 132 may comprise multiple fingerprint (FP) generators, and the command-related filter such as the filter 131 may comprise an SLBA filter, but the present invention is not limited thereto. According to some viewpoints, the dispatcher can act as a completion manager. In addition, the sinusoid-like symbol (which may represent fingerprint(s)) can be labeled next to some components, processing paths, etc., for indicating that the associated operations can be performed based on fingerprints.

In a situation where the one or more sets of Key-Value (KV) tables among the multiple tables of the deduplication module 100 comprises multiple sets of KV tables, any Dedup table manager (e.g. each Dedup table manager) of the multiple Dedup table managers can manage one set of KV tables among the multiple sets of KV tables, such as in-memory KV tables (labeled “In-memory KV” for brevity). Taking the uppermost Dedup table manager shown in FIG. 14 as an example of the any Dedup table manager, Keys and Values of the multiple KV sets in Tables #1 can be implemented by way of fingerprints (FPs) and SLBAs accompanied with pointers, respectively, for mapping the FPs to the SLBAs accompanied with the pointers, respectively (labeled “FP→(SLBA, pointer)” for brevity), and Keys and Values of the multiple KV sets in Tables #2 can be implemented by way of the SLBAs and the FPs, respectively, for mapping the SLBAs to the FPs, respectively (labeled “SLBA→FP” for brevity), but the present invention is not limited thereto. In addition, the tables in the DB 132D can be extended, and more particularly, can be distributed from at least one dedicated memory to at least one other storage such as the fingerprint storage 136, and can be divided into in-memory tables and in-storage tables. For example, the dedicated memory can be implemented by way of RAM, and the at least one other storage can be implemented by way of NVM, SSD, etc., but the present invention is not limited thereto. As the storage capacity of the other storage is typically greater than that of the dedicated memory, the in-memory tables (e.g. the tables in the dedicated memory) can store some KV pairs that are frequently used, and the in-storage tables (e.g. the tables in the other storage) can store some KV pairs that are not frequently used, such as some KV pair that are evicted or kicked from the in-memory tables due to storage capacity insufficiency of the in-memory tables. Therefore, the in-storage tables can be regarded as an extended DB of the DB 132D. As shown in FIG. 14, the any Dedup table manager can manage a set of in-memory tables (e.g. the one set of KV tables) among multiple sets of in-memory tables, and manage a set of in-storage tables corresponding to the set of in-memory tables, such as an FP-to-SLBA (FP2SLBA) table in an FP2SLBADB and an SLBA-to-FP (SLBA2FP) table in an SLBA2FP DB.

Based on the architecture shown in FIG. 14, the fingerprint engine 130 can receive input information, and try performing fingerprint-SLBA lookup according to the input information to generate a lookup result to be output information, in order to return the output information. For example, the input information can be expressed as follows:

(Volume ID, LBA, 4 KB data, SLBA, REFCNT);
where “Volume ID” and “LBA” in the above information may represent a volume ID of a certain volume (e.g. one of the multiple virtual volumes obtained from the storage pool architecture) and a volume LBA in this volume, respectively, “4 KB data” in the above information may represent a set of user data (e.g. the block data) carried by a command, “SLBA” in the above information may represent an SLBA corresponding to the address (Volume ID, LBA), and “REFCNT” may represent the reference count. In addition, the output information can be expressed as follows:
(match, des_SLBA);
where “match” may represent a flag corresponding to the resultant comparison result, for indicating whether the set of user data being the same as the any existing data is True (e.g. the match case) or False (e.g. the miss case), and “des_SLBA” may represent a destination SLBA, for indicating the storage location of the any existing data. As shown in FIG. 14, the fingerprint engine 130 (e.g. the dispatcher) can batch or collect a series of fingerprints such as (fp₀, fp₁, . . . , fpₙ) generated by the multiple fingerprint generators, and dispatch the series of fingerprints to the multiple Dedup table managers through the SLBA filter. In addition, the SLBA filter can perform request partition by FP, and more particularly, perform mapping operations from SLBAs to respective manager IDs of the multiple Dedup table managers (labeled “SLBA→manager ID” for brevity) according to a predetermined mapping rule, to try evenly assigning fingerprint-lookup tasks of the series of fingerprints to the multiple Dedup table managers. The multiple Dedup table managers can perform the fingerprint-lookup tasks to generate fingerprint-lookup results, respectively, for being used as the output information. For brevity, similar descriptions for this embodiment are not repeated in detail here.

According to some embodiments, the SLBA filter can be equipped with a cache, and can use the cache to record an SLBA-manager entry indicating an SLBA-manager relationship, for enhancing the processing speed, where the SLBA-manager entry may comprise an SLBA that has been received by the SLBA filter and further comprise a manager ID of a Dedup table manager that has processed a fingerprint-lookup task corresponding to this SLBA. As a result, the SLBA filter can collect multiple SLBA-manager entries such as this SLBA-manager entry in the cache thereof. When receiving a current SLBA, the SLBA filter can compare the current SLBA with one or more SLBAs of one or more SLBA-manager entries among the multiple SLBA-manager entries, to determine whether any matched SLBA in the cache thereof exists or not. If Yes, it is a cache hit case, wherein in the cache hit case, the SLBA filter can obtain a manager ID (e.g. 0x4) from the entry comprising the any matched SLBA as a target manager ID, and assign a current fingerprint-lookup task corresponding to the current SLBA (e.g. the fingerprint-lookup task of a current fingerprint associated with the current SLBA) to the Dedup table manager having this manager ID (e.g. 0x4); if No, it is a cache miss case, wherein in the cache miss case, the SLBA filter can determine a default ID (e.g. 0xF) which is different from all of the respective manager IDs of the multiple Dedup table managers as the target manager ID, for indicting the cache miss case, to trigger predetermined processing corresponding to the default ID. As a result, the multiple Dedup table managers can perform subsequent processing (e.g. the fingerprint-lookup tasks, etc.) according to whether it is the cache hit case or the cache miss case and/or according to which fingerprints belong to one of the multiple Dedup table managers. Regarding the cache miss case indicted by the default ID (e.g. 0xF), the predetermined processing corresponding to the default ID can be implemented by way of processing of a fingerprint lookup architecture that does not comprise the SLBA filter (e.g. an original design in another example), and therefore may need more input/output (I/O) processing and may cause greater number of I/O per second (IOPS). Regarding the cache hit case, the fingerprint engine 130 can operate with aid of the SLBA filter, and more particularly, classify multiple filtering results of the SLBA filter into multiple predetermined cases (e.g. Case 1 and Case 2, and/or some sub-cases such as Cases A-G), to perform respective processing of the multiple predetermined cases, thereby greatly enhancing the processing speed, where I/O processing and associated IOPS can be reduced. For example, some of the multiple predetermined cases may be related to various combinations of fingerprint match/mismatch (e.g. existence/non-existence of matched fingerprint) regarding the in-memory tables and the in-storage tables.

Some implementation details regarding the architecture shown in FIG. 14 can be described as follows. According to some embodiments, for each 4 KB of incoming data, the FP generator is used to calculate a fingerprint value (which can be simply referred to as fingerprint), for example, according to a predetermined function such as a cryptographic hash function (e.g. Secure Hash Algorithm 1 (SHA-1)). The fingerprint can serve as a feature for quickly identifying a 4 KB of data without byte-to-byte comparison. The duty of the dispatcher is to dispatch/schedule a request to the any Dedup table manger asynchronously and to act as a coordinator to collect the results from the multiple Dedup table managers for returning them orderly. For example, each Dedup table manager may look like a tiny Dedup module that can process one fingerprint each time. The any Dedup table manager can store the mapping relationships between fingerprints and SLBAs in both directions for each lookup, and therefore can answer whether an inputted fingerprint exists in the deduplication module 100 and to efficiently remove the fingerprint with respect to an SLBA.

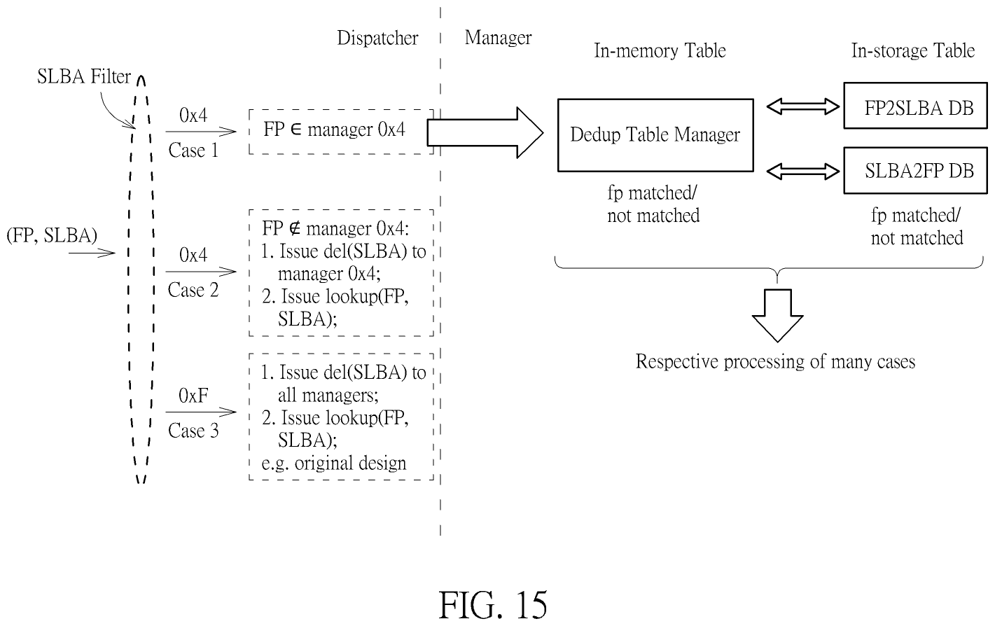

According to the embodiments respectively shown in FIGS. 15-18, the Dedup table manager(s) can be referred to as the table manager(s) or the manager(s) for brevity.

FIG. 15 illustrates an update request control scheme of the method shown in FIG. 2 according to an embodiment of the present invention. The first optimization is to reduce unnecessary delete requests issued to those table managers without holding the corresponding KV pairs. The adoption of SLBA Filter is to track which table manager an SLBA belongs to. When the filter returns 0xF, which means this SLBA is not used before, we just go through the same flow as the original design does (e.g. Case 3). Because the SLBA filter can be implemented as a cache for all mappings between SLBA and table manager ID, returning 0xF does not imply that the SLBA is not used before. Therefore, we still need to send each table manager a delete request. When a table manager ID is returned, e.g., 0x4 in the example, but the FP belongs a different table manager (not 0x4), one delete request is issued to table manager 0x4 and one lookup request of (FP, SLBA) is sent to the destined table manager (e.g. Case 2). On the other hand, when both FP and SLBA belongs to the same table manager, there will be multiple cases that need to be discussed separately (Case 1).

According to some embodiments, the deduplication module 100 (e.g. the fingerprint engine 130) may receive an update request regarding the current SLBA, for changing user data at the current SLBA, but the present invention is not limited thereto. The SLBA filter can obtain the current fingerprint and the current SLBA (labeled “(FP, SLBA)” for brevity), and generate a filtering result among the multiple filtering results. For example, the filtering result can be directed to the cache miss case indicated by the default ID (e.g. 0xF). More particularly, in Case 3, the dispatcher can perform the following operations:

(1) Issue del(SLBA) to all managers such as all Dedup table managers, to delete the fingerprint associated with the current SLBA;
(2) Issue lookup(FP, SLBA) to perform fingerprint lookup according to the current fingerprint (FP) and the current SLBA;
where the processing of the original design can be utilized. Regarding Case 1 and Case 2, the symbols “∈” and “∈” may represent “belonging to” and “not belonging to” respectively. The filtering result can be directed to the cache hit case indicated by the manager ID (e.g. 0x4), making the current fingerprint-lookup task be assigned to the Dedup table manager having this manager ID (e.g. 0x4). For brevity, similar descriptions for these embodiments are not repeated in detail here.

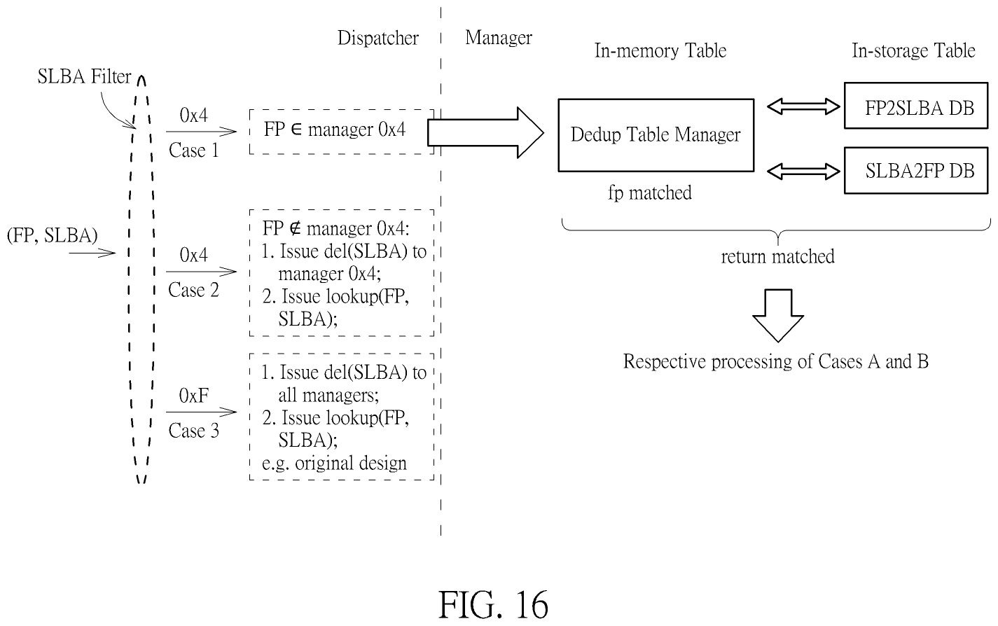

FIG. 16 illustrates some examples of the associated processing of the update request control scheme shown in FIG. 15 in a situation where FP is found on in-memory table. For example, the respective processing (e.g. respective operations of respective steps) of Cases A and B can be listed as follows:
Case A (return matched)
(1) Found a KV pair (FP, SLBA)→do nothing;
Case B (return matched)
(1) Found a KV pair (FP, SLBA′);
(2) (FP′, SLBA) must exist in this manager;
   (2a) Delete (FP′, SLBA) from in-memory table;
   (2b) If there exists a copy, delete (FP′, SLBA) from in-storage table;
   (2c) Cache management, etc.

When the inputted FP can find a match on the in-memory table, there will be two cases, i.e., Cases A and B. In Case A, if the SLBA in the matched KV pair from the in-memory table has the same value as the inputted SLBA, the fingerprint engine 130 can do nothing and deliver the best performance. In contrast to the previous design without further comparing the SLBA value, the fingerprint engine 130 can blindly delete the same KV pair first and then insert it again. In Case B, if the SLBA′ in the matched KV pair is different from the inputted SLBA, there will be more steps to do. The first thing is to find out the KV pair with an inputted SLBA. This SLBA must exist in this table manager as the SLBA filter reported its destination at the beginning (Case 1). After that, the fingerprint engine 130 can try to delete this KV pair (FP′, SLBA) on in-memory table only, or on in-storage table only, or on both in-memory and in-storage tables. The second thing is to insert the new KV pair (FP, SLBA′) into the in-memory table.

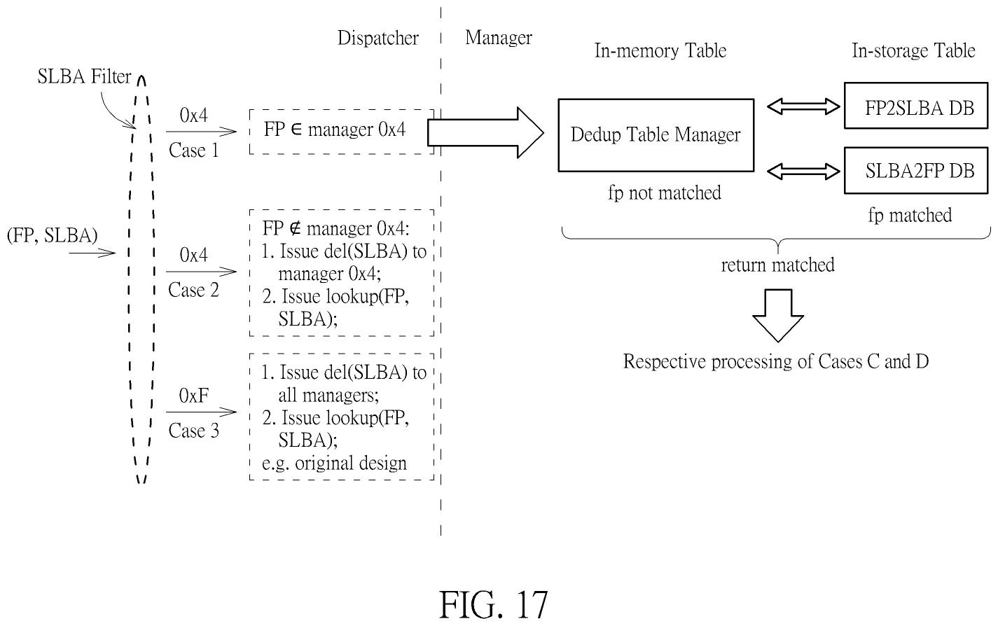

FIG. 17 illustrates some examples of the associated processing of the update request control scheme shown in FIG. 15 in a situation where FP is found on in-storage table. For example, the respective processing (e.g. respective operations of respective steps) of Cases C and D can be listed as follows:
Case C (return matched)
(1) Found a KV pair (FP, SLBA)→do nothing;
(2) Load (FP, SLBA) to in-memory table;
(3) If needed, evict one KV pair back from in-memory table to in-storage table;
Case D (return matched)
(1) Found a KV pair (FP, SLBA′);
(2) (FP′, SLBA) must exist in this manager→same delete operation as Case B;
(3) Load (FP, SLBA′) to in-memory table;
(4) If needed, evict one KV pair back from in-memory table to in-storage table.

When the inputted FP can find a match on the in-storage table instead of the in-memory table, there will be also two cases, i.e., Cases C and D. Case C is similar to Case A. When the SLBA found from the in-storage table has the same value as the inputted one, the KV pair (FP, SLBA) needs to be further loaded into the in-memory table (the different step). Loading a new KV pair may trigger additional writes due to the cache eviction. Case D is similar to Case B. The same delete operation used in Case B for KV pair (FP′, SLBA) is also needed in Case D. Similarly, loading the new KV pair (FP, SLBA′) to the in-memory table will possibly trigger extra operations for cache eviction.

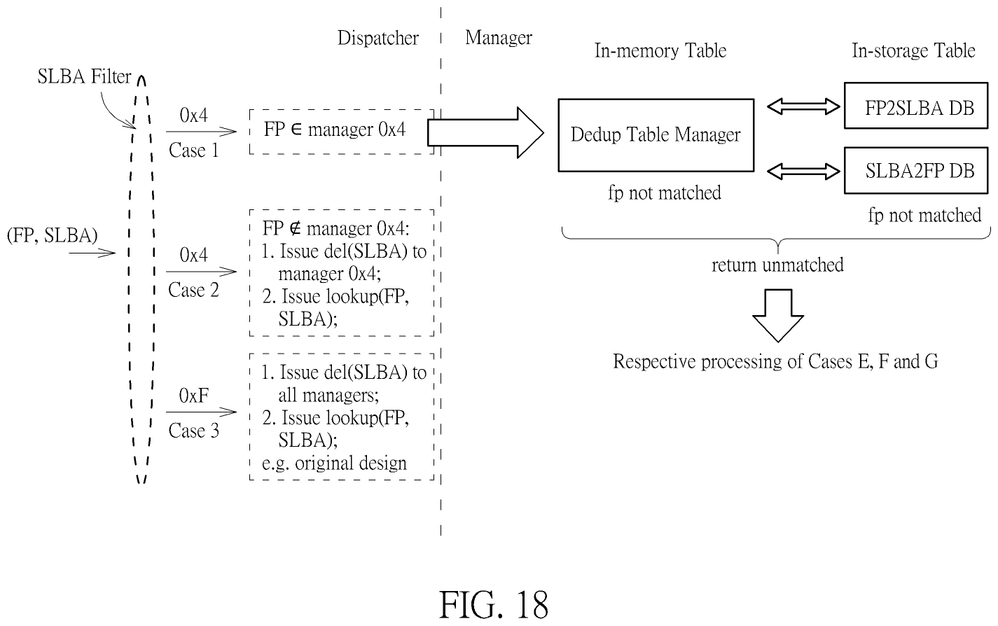

FIG. 18 illustrates some examples of the associated processing of the update request control scheme shown in FIG. 15 in a situation where FP is not found on any table. For example, the respective processing (e.g. respective operations of respective steps) of Cases E, F, and G can be listed as follows:
Case E (return unmatched)-(FP′, SLBA) found on in-memory table
(1) No need to modify SLBA→pointer;
(2) Delete FP′ →pointer;
(3) Insert FP→pointer;
Case F (return unmatched)-(FP′, SLBA) found on in-storage table
(1) Delete FP′ →SLBA from FP2SLBA DB;
(2) Delete SLBA→FP′ from SLBA2FP DB;
(3) Insert new KV pair (FP, SLBA) to in-memory table;
(4) If needed, evict one from in-memory table to in-storage table;
Case G (return unmatched)-(FP′, SLBA) found on in-memory and in-storage tables
(1) Delete in-storage mapping (the same as Steps 1-2 of Case F);
(2) Delete FP′ →pointer and insert FP→pointer (the same as Steps 1-3 of Case E).

When the inputted FP cannot find any match on both in-memory and in-storage tables, there will be three cases, i.e., Cases E, F, and G. In Case E, the KV pair with the same value of SLBA is only found on in-memory table. In this case, the fingerprint engine 130 only need to delete the mapping from FP′ to a KV item from the in-memory table. The KV pair is found by looking up the in-memory table that stores the mapping from a SLBA to the memory location of a KV item. In Case F, the KV pair with the same value of SLBA is only found on in-storage table. In this case, the fingerprint engine 130 may have to delete both mapping relations, i.e., FP2SLBA and SLBA2FP, from the in-storage tables because the new KV pair will be inserted into the in-memory table only. Note that, inserting new KV pair (FP, SLBA) may also trigger additional writes due to cache eviction. In Case G, the KV pair with the same value of SLBA is found on both in-storage and in-memory tables. In this case, the fingerprint engine 130 may need to delete the KV pair (FP′, SLBA) from the in-storage tables (same as the steps in Case F). The fingerprint engine 130 may also need to delete the mapping from FP′ to a KV item (same as the steps in Case E). For all cases discussed above, it can be concluded that most of the case do not need to do many unnecessary IOs. For example, there is no IO required in Case A, which greatly improves the lookup performance.

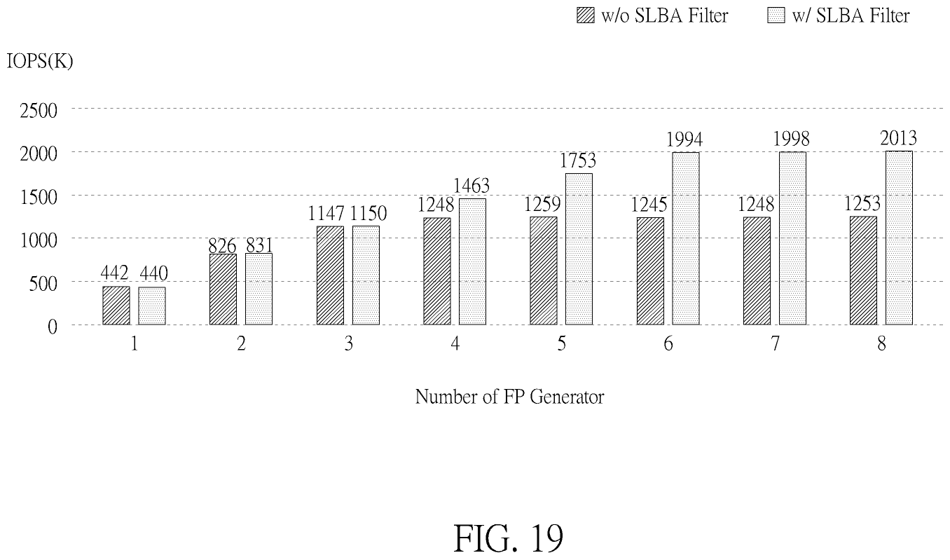

FIG. 19 illustrates enhanced scalability obtained from using the command-related filter according to an embodiment of the present invention (e.g. the associated parameters may comprise: Requests: 108, 0% dedupable, 99% update, manager count: 3). Regarding the scalability, the performance may scale up with respect to the FP generator number such as CPU number, but saturation may occur. As shown in FIG. 19, in comparison with the case that the SLBA filter is disabled (e.g. without (w/o) SLBA filter), the performance can be linearly scalable with more FP generators when the SLBA filter is enabled (e.g. with (w/) SLBA filter).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing deduplication management with aid of a command-related filter, comprising:
utilizing at least one program module on a host device to write user data into a storage device layer, and utilizing a fingerprint-based deduplication management module to create and store multiple fingerprints into a fingerprint storage to be respective representatives of the user data, for minimizing calculation loading regarding deduplication control; and
utilizing the command-related filter within the fingerprint-based deduplication management module to monitor multiple commands at a processing path, determine a set of commands regarding user-data change among the multiple commands according to addresses respectively carried by the set of commands, and convert the set of commands into a single command to eliminate one or more unnecessary commands among the set of commands.

2. The method of claim 1, further comprising:
executing the single command rather than all of the set of commands.

3. The method of claim 1, wherein the fingerprint-based deduplication management module comprises multiple sub-modules; and in addition to the command-related filter, the multiple sub-modules further comprise a deduplication module application programming interface (API), a deduplication manager, a fingerprint manager, a fingerprint generator, a fingerprint matcher, and a fingerprint data manager, configured to interact with one or more program modules outside the fingerprint-based deduplication management module, to perform deduplication management, to perform fingerprint management, to generate the multiple fingerprints, to perform fingerprint comparison regarding fingerprint matching detection, and to perform fingerprint data management on the fingerprint storage, respectively.

4. The method of claim 1, wherein the fingerprint-based deduplication management module comprises multiple sub-modules, and in addition to the command-related filter, the multiple sub-modules further comprise a deduplication module application programming interface (API), a deduplication manager, and a fingerprint manager; and the method further comprises:
utilizing the deduplication module API to interact with one or more program modules outside the fingerprint-based deduplication management module to receive at least one portion of the multiple commands;
utilizing the deduplication manager to send the at least one portion of the multiple commands toward the fingerprint manager through the command-related filter; and
utilizing the fingerprint manager to process in response to the single command.

5. The method of claim 1, wherein the fingerprint storage is implemented with a storage region of a storage-related hardware component under control of the fingerprint-based deduplication management module.

6. The method of claim 5, wherein the storage-related hardware component comprises any of a Random Access Memory (RAM), a Non-Volatile Memory (NVM), a Hard Disk Drive (HDD), and a Solid State Drive (SSD).

7. The method of claim 1, wherein the set of commands comprise the single command and the one or more unnecessary commands.

8. A host device, comprising:
a processing circuit, arranged to control the host device to perform fingerprint-based deduplication management, wherein:
at least one program module on the host device writes user data into a storage device layer, and a fingerprint-based deduplication management module creates and stores multiple fingerprints into a fingerprint storage to be respective representatives of the user data, for minimizing calculation loading regarding deduplication control; and
the command-related filter within the fingerprint-based deduplication management module monitors multiple commands at a processing path, determines a set of commands regarding user-data change among the multiple commands according to addresses respectively carried by the set of commands, and converts the set of commands into a single command to eliminate one or more unnecessary commands among the set of commands.

9. The host device of claim 8, further comprising:
a casing, arranged to install multiple components of the host device and said at least one storage device, wherein the multiple components of the host device comprise the processing circuit.

10. A storage server, comprising:
a host device, arranged to control operations of the storage server, the host device comprising:
a processing circuit, arranged to control the host device to perform fingerprint-based deduplication management in the storage server; and
a storage device layer, the storage device layer comprising at least one storage device that is coupled to the host device;
wherein:
at least one program module on the host device writes user data into the storage device layer, and a fingerprint-based deduplication management module creates and stores multiple fingerprints into a fingerprint storage to be respective representatives of the user data, for minimizing calculation loading regarding deduplication control; and
the command-related filter within the fingerprint-based deduplication management module monitors multiple commands at a processing path, determines a set of commands regarding user-data change among the multiple commands according to addresses respectively carried by the set of commands, and converts the set of commands into a single command to eliminate one or more unnecessary commands among the set of commands.
